(19) United States
(12) Patent Application Publication
(10) Pub. No.: US 2023/0370902 A1
(43) Pub. Date: Nov. 16, 2023

(54) Relay UE Selection for Transmission Over Sidelink

(71) Applicant: Telefonaktiebolaget LM Ericsson (publ), Stockholm (SE)

(72) Inventors: Min Wang, Luleå (SE); Zhang Zhang, Beijing (CN); Zhang Fu, Stockholm (SE)

(21) Appl. No.: 18/029,131

(22) PCT Filed: Sep. 24, 2021
(86) PCT No.: PCT/CN2021/120311

§ 371 Date: Mar. 29, 2023

(30) Foreign Application Priority Data
Sep. 29, 2020 (WO) PCT/CN2020/119045

(51) Int. Cl. H04W 28/24; H04W 28/02

(52) U.S. Cl. CPC H04W 28/24; H04W 28/0268; H04W 88/04

(57) ABSTRACT

The present disclosure is related to a user equipment (UE), a relay UE, and methods performed by the UEs for relay UE selection for transmission over sidelink (SL). The method at the UE for selecting a relay UE for transmission over a sidelink comprises: communicating, with a second UE, a first message comprising a first quality of service (QoS) parameter, which has a first value and is associated with a sidelink to be established between the UE and the second UE; determining whether an agreement on a value of the first QoS parameter for the sidelink can be reached with the second UE or not at least partially based on the first value of the first QoS parameter; and determining whether the second UE is a relay UE candidate or not at least partially based on the determination of whether the agreement can be reached or not.

### CROSS-REFERENCE TO RELATED APPLICATION(S)

This application claims priority to the PCT International Application No. PCT/CN2020/119045, entitled “RELAY UE SELECTION FOR TRANSMISSION OVER SIDELINK”, filed on Sep. 29, 2020, which is incorporated herein by reference in its entirety.

### TECHNICAL FIELD

The present disclosure is related to the field of telecommunications, and in particular, to a user equipment (UE), a relay UE, and methods performed by the UEs for relay UE selection for transmission over sidelink (SL).

### BACKGROUND

Networks have always been hierarchical in nature. Devices have connected to and communicated with one or more base stations ever since the birth of cellular communications. However, new technology enablers in 5G New Radio (NR) will allow devices to connect directly to one another using a technique called sidelink communications. Sidelink is the new communication paradigm in which cellular devices are able to communicate without relaying their data via the network. That means vehicles, robots, and even consumer gadgets could create their own ad hoc networks without using the radio access network as an intermediary.

In the past decade new types of cellular services that go beyond traditional mobile broadband have had a strong impact on the scoping and development of the 5G NR standard. These new cellular services were motivated by the business and economic needs of making the 3GPP ecosystem capable of supporting industrial requirements ranging from direct automotive communication between vehicles to industrial automation with Ultra-Reliable Low-Latency Communication (URLLC) for mission-and business-critical applications. But these same technologies can also be used for consumers to enhance their communication experience. For instance, sidelink proximity services would allow devices to discover and communicate with one another at extremely high data rates and low latency, making them ideal for peer-to-peer gaming and streaming services as well as enhanced AR, VR and other wearable device communications.

In contrast with uplink and downlink between a user equipment (UE) and a base station, where resource allocation and link adaptation are controlled by the network, in sidelink the device performs both functions autonomously. In other words, the device gains more control of how to use network resources. At the same time, it is expected that 3GPP upcoming Release will introduce support for sidelink-based relaying and that in future releases multi-link relay will also be considered. Sidelink is also a candidate for future releases as an Industrial Internet of Things (IoT) enabler. By restricting the communication link to one hop, latency is greatly reduced, which is key to mission-critical industrial applications. Furthermore, sidelink is a potential solution for public safety ensuring direct communication or relayed communication between devices.

Another potential use case is multi-hop relaying where multiple sidelink connections are used to leap from/to device to achieve less power consumption, overcome link budget constraints, and enhance latency and reliability. Gaming and entertainment services with AR/VR can also take advantage of sidelink, as will body networks, using direct 5G connections to replace the Bluetooth and eventually Wi-Fi links that currently connect these devices. The result could be a revolutionary change in the communication architecture for many consumer devices. Instead of providing a different radio interface for every use case, device vendors could rely solely on 5G as the link for wide-area, local-area and personal-area communications.

### SUMMARY

According to a first aspect of the present disclosure, a method at a user equipment (UE) for selecting a relay UE for transmission over a sidelink is provided. The method comprises: communicating, with a second UE, a first message comprising a first quality of service (QoS) parameter, which has a first value and is associated with a sidelink to be established between the UE and the second UE; determining whether an agreement on a value of the first QoS parameter for the sidelink can be reached with the second UE or not at least partially based on the first value of the first QoS parameter; and determining whether the second UE is a relay UE candidate or not at least partially based on the determination of whether the agreement can be reached or not.

In some embodiments, the step of communicating, with a second UE, a first message comprising a first QoS parameter comprises: transmitting, to the second UE, the first message comprising the first QoS parameter which has the first value required by the UE. In some embodiments, the step of determining whether an agreement can be reached or not comprises: receiving, from the second UE, a second message indicating whether the required first value of the first QoS parameter can be fulfilled or not; and determining whether the agreement can be reached or not depending on whether the required first value of the first QoS parameter can be fulfilled or not.

In some embodiments, the step of determining whether an agreement can be reached or not comprises: receiving, from the second UE, a second message comprising the first QoS parameter which has a second value supported by the second UE; and determining whether the agreement can be reached or not depending on whether the second value of the first QoS parameter is acceptable or not. In some embodiments, when the UE is being served by a serving access network (AN) node, before the step of transmitting, to the second UE, the first message comprising the first QoS parameter, the method further comprises: receiving, from the serving AN node, an indication of the first value of the first QoS parameter.

In some embodiments, the step of communicating, with a second UE, a first message comprising a first QoS parameter comprises: receiving, from the second UE, the first message comprising the first QoS parameter which has the first value supported by the second UE. In some embodiments, the step of determining whether an agreement can be reached or not comprises: determining whether the agreement can be reached or not depending on whether the first value of the first QoS parameter is acceptable or not. In some embodiments, when the UE is being served by a serving access network (AN) node, the step of determining whether an agreement can be reached or not comprises: transmitting, to the serving AN node, an indication of the first value of the first QoS parameter; receiving, from the serving AN node, an indication whether the first value is acceptable or not; and determining whether an agreement can be reached or not depending on the indication.

In some embodiments, the first QoS parameter is related to bit rate. In some embodiments, the first QoS parameter comprises at least one of: ingress aggregate maximum bit rate (AMBR), egress AMBR, ingress maximum flow bit rate (MFBR), and egress MFBR. In some embodiments, the first QoS parameter has a value which is set per UE, per session, per radio access technology (RAT), per link, per hop, per flow, or per radio bearer. In some embodiments, the method further comprises: establishing the sidelink with the second UE in response to determining that the second UE is a relay UE candidate. In some embodiments, if there are more than one relay UE candidate, the method further comprising: selecting one of the relay UE candidates which has the best measured link quality; and establishing the sidelink with the selected relay UE candidate. In some embodiments, if there are more than one relay UE candidate, the method further comprising: determining one or more relay UE candidates from the more than one relay UE candidate, each of which has a higher measured link quality than a configured threshold; selecting a relay UE candidate from the determined one or more relay UE candidates which supports the highest value of the first QoS parameter; and establishing the sidelink with the selected relay UE candidate.

In some embodiments, the first message further comprises a second parameter indicating a load level and/or a congestion level at the UE or the second UE from which the first message is transmitted, and wherein the step of determining whether the second UE is a relay UE candidate or not at least partially based on the determination of whether the agreement can be reached or not further comprises: determining that the second UE is not a relay UE candidate in response to determining that the load level and/or the congestion level is not acceptable by the UE or the second UE to which the first message is transmitted.

In some embodiments, the first message further comprises a third parameter indicating a priority level for one of the UE, the sidelink to be established by the UE, and the RAT to be used for the sidelink. In some embodiments, the step of determining whether the second UE is a relay UE candidate or not at least partially based on the determination of whether the agreement can be reached or not further comprises:

receiving, from the second UE, a second message indicating at least one of following: whether the required first value of the first QoS parameter can be fulfilled or not; whether the second UE supports a priority based preemption; and whether a third UE has to be preempted by the second UE before the sidelink between the UE and the second UE can be established, and determining whether the second UE is a relay UE candidate or not depending on the second message.

In some embodiments, the step of determining whether the second UE is a relay UE candidate or not depending on the second message comprises: determining that the second UE is a relay UE candidate based on the second message indicating that the second UE supports the priority based preemption. In some embodiments, the step of determining whether the second UE is a relay UE candidate or not depending on the second message comprises: determining that the second UE is a relay UE candidate based on the second message indicating that the third UE does not have to be preempted by the second UE before the sidelink between the UE and the second UE can be established. In some embodiments, the first message further comprises a fourth parameter indicating whether the second UE supports a priority based preemption or not, wherein the step of determining whether the second UE is a relay UE candidate or not at least partially based on the determination of whether the agreement can be reached or not further comprises: determining that the second UE is not a relay UE candidate if the fourth parameter indicates that the second UE does not support the priority based preemption. In some embodiments, the step of determining whether an agreement on a value of the first QoS parameter can be reached or not comprises: determining whether an agreement on a value of the first QoS parameter can be reached or not by an admission control procedure executed at the UE at least partially based on the first QoS parameter and radio channel quality.

According to a second aspect, a user equipment (UE) is provided. The UE comprises: a processor; and a memory storing instructions which, when executed by the processor, cause the processor to perform any of the methods of the first aspect.

According to a third aspect, a method at a relay user equipment (UE) for facilitating a UE in transmission over a sidelink is provided. The method comprises: communicating, with the UE, a first message comprising a first quality of service (QoS) parameter, which has a first value and is associated with a sidelink to be established between the UE and the relay UE; determining whether an agreement on a value of the first QoS parameter for the sidelink can be reached with the UE or not at least partially based on the first value of the first QoS parameter; and determining whether the relay UE can serve the UE or not at least partially based on the determination of whether the agreement can be reached or not.

In some embodiments, the step of communicating, with the UE, a first message comprising a first QoS parameter comprises: receiving, from the UE, the first message comprising the first QoS parameter which has the first value required by the UE. In some embodiments, the step of determining whether an agreement can be reached or not comprises: determining whether the agreement can be reached or not depending on whether the required first value of the first QoS parameter can be fulfilled or not by the relay UE. In some embodiments, the method further comprises: transmitting, to the UE, a second message indicating whether the required first value of the first QoS parameter can be fulfilled or not based on the determining whether the agreement can be reached or not. In some embodiments, the step of determining whether an agreement can be reached or not comprises: transmitting, to the UE, a second message comprising the first QoS parameter which has a second value supported by the relay UE. In some embodiments, when the relay UE is being served by a serving access network (AN) node, the step of determining whether the agreement can be reached or not depending on whether the required first value of the first QoS parameter can be fulfilled or not by the relay UE comprises: transmitting, to the serving AN node, an indication of the required first value of the first QoS parameter; receiving, from the serving AN node, an indication of whether the required first value can be supported or not; and determining whether the agreement can be reached or not based on the indication.

In some embodiments, the step of communicating, with the UE, a first message comprising a first QoS parameter comprises: transmitting, to the UE, the first message comprising the first QoS parameter which has the first value supported by the relay UE. In some embodiments, the step of determining whether an agreement can be reached or not comprises: receiving, from the UE, a second message indicating whether the supported first value of the first QoS parameter can be accepted or not; and determining whether the agreement can be reached or not depending on whether the supported first value of the first QoS parameter can be accepted or not.

In some embodiments, when the relay UE is being served by a serving access network (AN) node, before the step of transmitting, to the UE, the first message comprising the first QoS parameter, the method further comprises: receiving, from the serving AN node, an indication of the first value of the first QoS parameter. In some embodiments, the first QoS parameter is related to bit rate. In some embodiments, the first QoS parameter comprises at least one of: ingress aggregate maximum bit rate (AMBR), egress AMBR, ingress maximum flow bit rate (MFBR), and egress MFBR. In some embodiments, the first QoS parameter has a value which is set per UE, per session, per radio access technology (RAT), per link, per hop, per flow, or per radio bearer. In some embodiments, the method further comprises: establishing the sidelink with the UE.

In some embodiments, the first message further comprises a second parameter indicating a load level and/or a congestion level at the UE or the relay UE from which the first message is transmitted, and wherein the step of determining whether the relay UE can serve the UE or not at least partially based on the determination of whether the agreement can be reached or not further comprises: determining that the relay UE cannot serve the UE in response to determining that the load level and/or the congestion level is not acceptable by the UE or the relay UE to which the first message is transmitted. In some embodiments, the first message further comprises a third parameter indicating a priority level for one of the UE, the sidelink to be established by the UE, and the RAT to be used for the sidelink. In some embodiments, the step of determining whether the relay UE can serve the UE or not further comprises: determining the relay UE cannot serve the UE in response to determining that the priority level is lower than or equal to a priority level associated with a third UE which is currently being served by the relay UE and that the required first value of the first QoS parameter cannot be fulfilled without stopping serving the third UE.

In some embodiments, the step of determining whether the relay UE can serve the UE or not further comprises: transmitting, to the UE, a second message indicating at least one of following: whether the required first value of the first QoS parameter can be fulfilled or not by the relay UE; whether the relay UE supports a priority based preemption; and whether a third UE has to be preempted by the relay UE before the sidelink between the UE and the relay UE can be established.

In some embodiments, the first message further comprises a fourth parameter indicating whether the relay UE supports a priority based preemption or not. In some embodiments, the step of determining whether an agreement on a value of the first QoS parameter can be reached or not comprises: determining whether an agreement on a value of the first QoS parameter can be reached or not by an admission control procedure executed at the relay UE at least partially based on the first QoS parameter and radio channel quality.

According to a fourth aspect, a relay user equipment (UE) is provided. The relay UE comprises: a processor; and a memory storing instructions which, when executed by the processor, cause the processor to perform any of the methods of the third aspect.

According to a fifth aspect, a computer program comprising instructions is provided. The instructions, when executed by at least one processor, cause the at least one processor to carry out any of the methods of any of the first aspect and the third aspect.

According to a sixth aspect, a carrier containing the computer program of the fifth aspect, wherein the carrier is one of an electronic signal, optical signal, radio signal, or computer readable storage medium.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunications network in which relay selection for transmission over sidelink according to an embodiment of the present disclosure may be applicable.

FIG. 2 is a diagram illustrating an architecture model using a layer 3 (L3) UE-to-Network relay in which relay selection for transmission over sidelink according to an embodiment of the present disclosure may be applicable.

FIG. 3 is a diagram illustrating an exemplary protocol stack for the architecture model shown in FIG. 2.

FIG. 4 is a diagram illustrating an exemplary message flow between the nodes of the architecture model shown in FIG. 2 for sidelink relay.

FIG. 5A and FIG. 5B are diagrams illustrating exemplary User Plane (UP) and Control Plane (CP) protocol stacks for an architecture model using a layer 2 (L2) UE-to-Network relay, respectively, in which relay selection for transmission over sidelink according to an embodiment of the present disclosure may be applicable.

FIG. 6 is a diagram illustrating an exemplary message flow between the nodes of the architecture model shown in FIG. 5 for sidelink relay.

FIG. 7 is a diagram illustrating an exemplary message flow for a relay discovery procedure in which relay selection for transmission over sidelink according to an embodiment of the present disclosure may be applicable.

FIG. 8 is a diagram illustrating an exemplary message flow for relay selection initiated by a remote UE according to an embodiment of the present disclosure.

FIG. 9 is a diagram illustrating an exemplary message flow for relay selection initiated by a relay UE according to an embodiment of the present disclosure.

FIG. 10 is a diagram illustrating an exemplary message flow for relay selection involving parameter negotiation according to an embodiment of the present disclosure.

FIG. 11 is a diagram illustrating an exemplary message flow for relay selection involving multiple relay UEs according to an embodiment of the present disclosure.

FIG. 12 is a diagram illustrating an exemplary message flow for relay selection involving other parameters than the quality of service (QoS) parameters according to an embodiment of the present disclosure.

FIG. 13 is a diagram illustrating an exemplary message flow for relay selection involving priority according to an embodiment of the present disclosure.

FIG. 14 is a flow chart of an exemplary method at a remote UE for selecting a relay UE for transmission over sidelink according to an embodiment of the present disclosure.

FIG. 15 is a flow chart of an exemplary method at a relay UE for facilitating a remote UE in transmission over sidelink according to an embodiment of the present disclosure.

FIG. 16 schematically shows an embodiment of an arrangement which may be used in a remote UE and/or a relay UE according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof. It will be also understood that the terms “connect(s),”“connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5th Generation New Radio (5G NR), the present disclosure is not limited thereto. In fact, as long as relay UE selection is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, an access network (AN) node, or any other equivalents. Further, the term “node” used herein may refer to a UE, a functional entity, a network entity, a network element, a network equipment, or any other equivalents.

Further, following 3GPP documents are incorporated herein by reference in their entireties:
3GPP TR 23.752 V0.5.0, (2020-09), 3rd Generation Partnership Project; Technical Specification Group Services and System Aspects; Study on system enhancement for Proximity based Services (ProSe) in the 5G System (5GS) (Release 17);
3GPP TS 23.303 V16.0.0 (2020-07), 3rd Generation Partnership Project;

Technical Specification Group Services and System Aspects; Proximity-based services (ProSe); Stage 2, (Release 16); and
3GPP TS 23.287 V16.4.0 (2020-09), 3rd Generation Partnership Project; Technical Specification Group Services and System Aspects; Architecture enhancements for 5G System (5GS) to support Vehicle-to-Everything (V2X) services (Release 16).

Before some embodiments of the present disclosure are described, a brief introduction of sidelink will be given below.

Similar to Long Term Evolution (LTE), NR uses the OFDM (Orthogonal Frequency Division Multiplexing) technology in the downlink (i.e. from a network node, gNB, eNB, or base station to a user equipment or UE). The basic NR physical resource over an antenna port can thus be seen as a time-frequency grid, where a resource block (RB) in a 14-symbol slot is used. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ∈{0, 1, 2, 3, 4}. Δf=15 kHz is the basic (or reference) subcarrier spacing that is also used in LTE.

In the time domain, downlink and uplink transmissions in NR will be organized into equally-sized subframes of 1 ms each, similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz and a slot consists of 14 OFDM symbols as mentioned above.

Downlink transmissions are dynamically scheduled, i.e., in each slot the gNB may transmit downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Downlink Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH.

In addition to PDCCH and PDSCH, there are also other channels and reference signals transmitted in the downlink, including Synchronous Signal and PBCH Block (SSB), Channel State Information-Reference Signal (CSI-RS), etc.

Uplink data transmissions, carried on Physical Uplink Shared Channel (PUSCH), can also be dynamically scheduled by the gNB by transmitting a DCI. The DCI (which is transmitted in the DL region) always indicates a scheduling time offset so that the PUSCH is transmitted in a slot in the UL region.

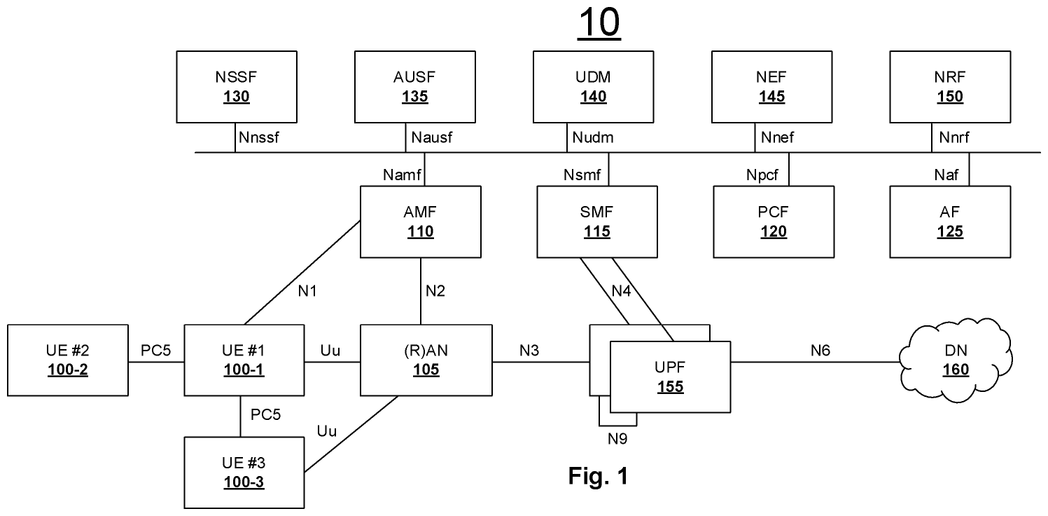

FIG. 1 is a diagram illustrating an exemplary telecommunications network 10 in which relay selection for transmission over sidelink according to an embodiment of the present disclosure may be applicable. Although the telecommunications network 10 is a network defined in the context of 5G NR, the present disclosure is not limited thereto.

As shown in FIG. 1, the network 10 may comprise one or more UEs 100-1, 100-2, and 100-3 (collectively, UE(s) 100) and a (radio) access network ((R)AN) 105, which could be a base station, a Node B, an evolved NodeB (eNB), a gNB, or an AN node which provides the UEs 100 with access to the network 10. Further, the network 10 may comprise its core network portion comprising (but not limited to) an Access & Mobility Management Function (AMF) 110, an Session Management Function (SMF) 115, a Policy Control Function (PCF) 120, an Application Function (AF) 125, a Network Slice Selection Function (NSSF) 130, an AUthentication Server Function (AUSF) 135, a Unified Data Management (UDM) 140, a Network Exposure Function (NEF) 145, a Network Repository Function (NRF) 150, and one or more UPFs 155. As shown in FIG. 1, these entities may communicate with each other via the service-based interfaces, such as, Namf, Nsmf, Npcf, etc. and/or the reference points, such as, N1, N2, N3, N6, N9, etc.

Further, as shown in FIG. 1, the UEs may communicate with each other via sidelinks over the reference point PC5.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

Here, some of the functions shown in FIG. 1, such as AMF 110, SMF 115, UPFs 155, which may be involved in the embodiments of the present disclosure will be described in detail below.

Referring to FIG. 1, the AMF 110 may provide most of the functions that the mobility management entity (MME) provides in a 4G network as mentioned above. Below please find a brief list of some of its functions:
Terminates the RAN CP interface (N2);
Non-access stratum (NAS) signaling;
NAS ciphering and integrity protection;
Mobility Management (MM) layer NAS termination;
Session Management (SM) layer NAS forwarding;
Authenticates UE;
Manages the security context;
Registration management;
Connection management;
Reachability management;
Mobility Management; and
Apply mobility related policies from PCF (e.g. mobility restrictions).

Further, the SMF 115 may provide the session management functions that are handled by the 4G MME, Secure Gateway-Control plane (SGW-C), and PDN Gateway-Control plane (PGW-C). Below please find a brief list of some of its functions:
Allocates IP addresses to UEs;
NAS signaling for session management (SM);
Sends QoS and policy information to RAN via the AMF;
Downlink data notification;
Select and control UPF for traffic routing;
Acts as the interface for all communication related to offered user plane services; and
Lawful intercept—control plane.

Further, the UPFs 155 is essentially a fusion of the data plane parts of the SGW and PGW, as mentioned above. In the context of the Control and User Plane Separation (CUPS) architecture: Evolved Packet Core (EPC) SGW-U+EPC PGW-U→5G UPF.

The UPFs 155 may perform the following functions:
Packet routing and forwarding
Packet inspection and QoS handling, and the UPF may optionally integrate a Deep Packet Inspection (DPI) for packet inspection and classification;
Connecting to the Internet POP (Point of Presence), and the UPF may optionally integrate the Firewall and Network Address Translation (NAT) functions;
Mobility anchor for Intra RAT and Inter-RAT handovers;
Lawful intercept—user plane; and
Maintains and reports traffic statistics.

As shown in FIG. 1, the UPFs 155 are communicatively connected to the Data Network (DN) 160 which may be, or in turn communicatively connected to, the Internet, such that the UEs 100 may finally communicate its user plane data with other devices outside the network 10, for example, via the RAN 105 and the UPFs 155.

For the sidelink transmissions over PC5 shown in FIG. 1, they are specified for 3GPP Rel. 16. These are enhancements of the ProSe (proximity-based services) specified for LTE. Four new enhancements are particularly introduced to NR sidelink transmissions as follows:
Support for unicast and groupcast transmissions are added in NR sidelink. For unicast and groupcast, the Physical Sidelink Feedback Channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of Physical Sidelink Shared Channel (PSCCH).
To achieve a high connection density, congestion control and thus the QoS management is supported in NR sidelink transmissions.

To enable the above enhancements, new physical channels and reference signals are introduced in NR (available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (SL version of PUCCH): The PSFCH is transmitted by a sidelink receiver UE for unicast and groupcast, which conveys 1 bit information over 1 RB for the hybrid automatic repeat request (HARQ) acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, the transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitting the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (e.g., UE/eNB/gNB) sending the S-PSS/S-SSS is called a synchronization source. In some embodiments, there are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. In some embodiments, the SSB may be transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. In some embodiments, the PT-RS may be only applicable for FR2 (frequency range 2) transmission.

Another new feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for PRoSE in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:
Dynamic grant: When the traffic to be sent over sidelink arrives at a transmitter UE, this UE should launch the four-message exchange procedure to request sidelink resources from a gNB (that is, SR (scheduling request) on UL, grant, BSR (buffer state report) on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB (transport block). As a result, this kind of grant is suitable for traffic with a loose latency requirement.
Configured grant: For the traffic with a strict latency requirement, performing the four-message exchange procedure to request sidelink resources may result in an unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC (cyclic redundancy check) is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring Reference Signal Received Power (RSRP) on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

There are device-to-device (D2D) discovery procedures for detection of services and applications offered by other UEs in close proximity. This discovery procedure is a part of LTE Rel 12 and Rel 13. The discovery procedure has two modes, mode A based on open announcements (broadcasts) and mode B, which is based on request/response mechanism. The discovery mechanism is controlled by the application layer (ProSe). The discovery message is sent on the Physical Sidelink Discovery Channel (PSDCH) which is not available in NR. Also, there is a specific resource pool for announcement and monitoring of discovery messages. The discovery procedure can be used to detect UEs supporting certain services or applications before initiating direct communication.

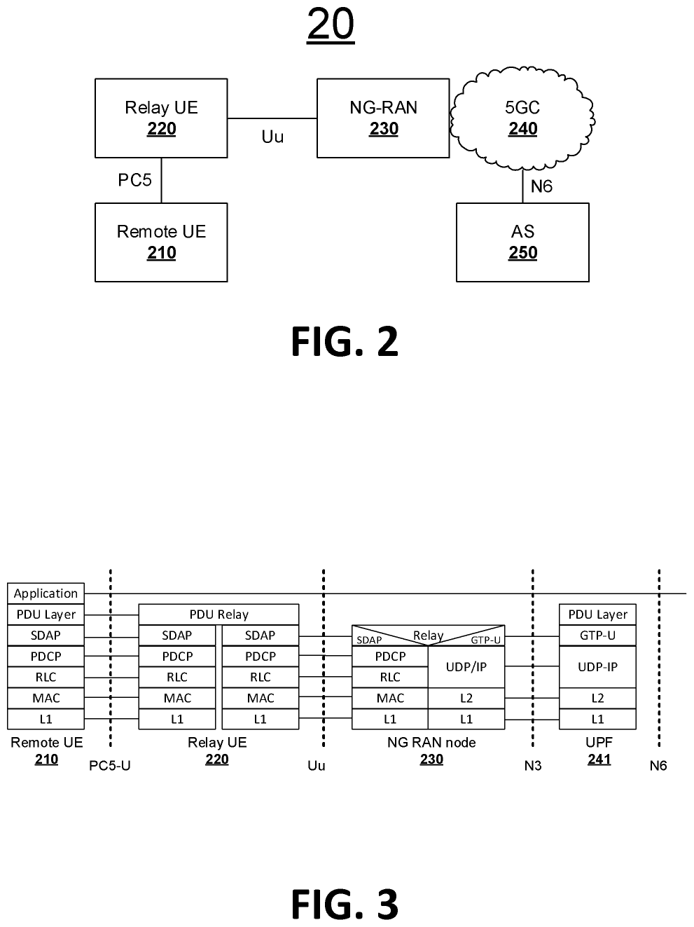

In the 3GPP TR 23.752 v0.5.0 clause 6.6, a layer-3 based UE-to-Network relay is described. FIG. 2 is a diagram illustrating an architecture model 20 using a layer 3 (L3) UE-to-Network relay 220 in which relay selection for transmission over sidelink according to an embodiment of the present disclosure may be applicable. As shown in FIG. 2, the architecture model 20 may comprise a remote UE 210, a relay UE 220, a NG-RAN node 230, a 5G core network (5GC) 240, and an application server (AS) 250. The remote UE 210 may communicate with the relay UE 220 via the reference point PCS, the relay UE 220 may communicate with the NG-RAN node 230 via the reference point Uu, and the 5GC 240 may communicate with the AS 250 via the reference point N6. However, the present disclosure is not limited thereto.

The ProSe 5G UE-to-Network Relay entity (e.g., the relay UE 220 shown in FIG. 2) provides the functionality to support connectivity to the network for Remote UEs (e.g. the remote UE 210 shown in FIG. 2). It can be used for both public safety services and commercial services (e.g. interactive service). A UE is considered to be a Remote UE for a certain ProSe UE-to-Network relay if it has successfully established a PC5 link to this ProSe 5G UE-to-Network Relay. A Remote UE can be located within NG-RAN coverage (in-coverage) or outside of NG-RAN coverage (out-of-coverage).

Remote UE may perform communication path selection between direct Uu path (e.g., the UE #1 100-1 and UE #3 100-3 shown in FIG. 1) and indirect Uu path (e.g., the UE #2 100-2 shown in FIG. 1 and the remote UE 210 shown in FIG. 2) based on the link quality and the configured threshold (pre-configured or provided by NG-RAN). For example, if Uu link quality exceeds configured threshold, the direct Uu path is selected. Otherwise, the indirect Uu path is selected by performing the UE-to-Network Relay discovery and selection.

The relay UE 220 shall relay unicast traffic (UL and DL) between the remote UE 210 and the network (e.g. the NG-RAN node 230, the AS 250, etc.). The relay UE 220 shall provide generic function that can relay any IP, Ethernet or Unstructured traffic;
For IP traffic over PC5 reference point, the relay UE 220 uses IP type Protocol Data Unit (PDU) Session towards 5GC 240.
For Ethernet traffic over PC5 reference point, the relay UE 220 can use Ethernet type PDU Session or IP type PDU Session towards 5GC 240.
For Unstructured traffic over PC5 reference point, the relay UE 220 can use Unstructured type PDU Session or IP type PDU Session (i.e. IP encapsulation/de-capsulation by UE-to-Network Relay) towards 5GC 240.

The type of traffic supported over PC5 reference point is indicated by the relay UE 220 e.g. using the corresponding Relay Service Code. The relay UE 220 may determine the PDU Session Type based on, e.g. ProSe policy/parameters, UE Route Selection Policy (URSP) rule, Relay Service Code, etc.

IP type PDU Session and Ethernet type PDU Session can be used to support more than one remote UEs 210 while Unstructured type PDU Session can be used to support only one remote UE 210.

FIG. 3 is a diagram illustrating an exemplary protocol stack for the architecture model 20 shown in FIG. 2. Hop-by-hop security is supported in the PC5 link and Uu link. If there are requirements beyond hop-by-hop security for protection of remote UE 210's traffic, security over PDU layer needs to be applied.

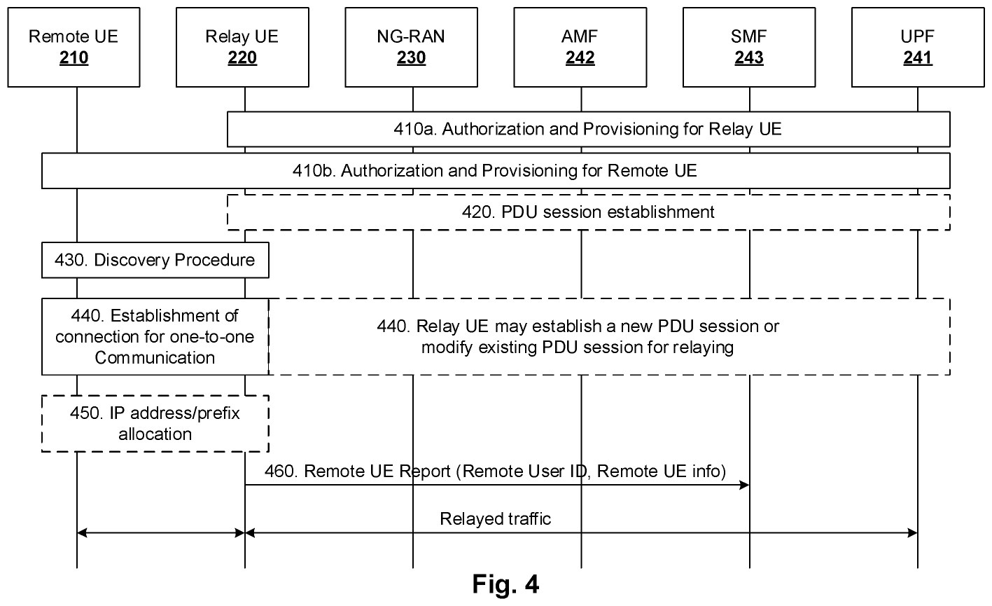

FIG. 4 is a diagram illustrating an exemplary message flow between the nodes of the architecture model 20 shown in FIG. 2 for sidelink relay.

A relay capable UE 220 may register to the network (if not already registered) and establish a PDU session enabling the necessary relay traffic, or it may need to connect to additional PDU session(s) or modify the existing PDU session in order to provide relay traffic towards remote UE(s) 210. PDU session(s) supporting the relay UE 220 shall only be used for remote UE(s) 210's relay traffic.

At step 410a and 410b, during the registration procedure, authorization and provisioning is performed for the relay UE 220 (410a) and the remote UE 210 (410b).

At step 420, the relay UE 220 may establish a PDU session for relaying with default PDU session parameters received in step 410a or pre-configured in the relay UE 220, e.g. Single-Network Slice Selection Assistance Information (S-NSSAI), Data Network Name (DNN), Session and Service Continuity (SSC) mode or PDU Session Type. In case of IP PDU Session Type and IPv6, the relay UE 220 may obtain the IPv6 prefix via prefix delegation function from the network as defined in TS 23.501.

At step 430, based on the authorization and provisioning in step 410b, the remote UE 210 may perform discovery of a relay UE using any solution which may described later or any other appropriate solution. As part of the discovery procedure the remote UE 210 may learn about the connectivity service the relay UE 220 provides.

At step 440, the remote UE 210 may select the relay UE 220 and establish a connection for one-to-one direct communication as described in TS 23.287.

If there is no PDU session satisfying the requirements of the PC5 connection with the remote UE 210, e.g. S-NSSAI, DNN, QoS, the relay UE 220 may initiate a new PDU session establishment or modification procedure for relaying.

According to the PDU Session Type for relaying, the relay UE 220 may perform relaying function at the corresponding layer, e.g. acts as an IP router when the traffic type is IP, acts as an Ethernet switch when the traffic type is Ethernet, and performs generic forwarding for Unstructured traffic.

When the relay UE 220 uses Unstructured PDU session type for Unstructured traffic over PC5 reference point, it may create a mapping between the PC5 Link Identifier and the PDU Session ID, and a mapping between Packet Flow Identifier (PFI) for PC5 L2 link and the QoS Flow Identifier (QFI) for the PDU Session.

When the relay UE 220 uses IP PDU session type for Ethernet or Unstructured traffic over PC5 reference point, it may locally assign an IP address/prefix for the remote UE 210 and use that to encapsulate the data from the remote UE 210. For downlink traffic, the relay UE 220 may decapsulate the traffic from the IP headers and forwards to the corresponding remote UE 210 via PC5 reference point.

At step 450, for IP PDU Session Type and IP traffic over PC5 reference point, IPv6 prefix or IPv4 address may be allocated for the remote UE 210 as it is defined in TS 23.303 clauses 5.4.4.2 and 5.4.4.3. From this point, the uplink and downlink relaying can start. For downlink traffic forwarding, the PC5 QoS Rule may be used to map the downlink IP packet to the PC5 QoS Flow. For uplink traffic forwarding, the 5G QoS Rule may be used to map the uplink IP packet to the Uu QoS Flow.

At step 460, the relay UE 220 may send a Remote UE Report (Remote User ID, Remote UE info) message to the SMF 243 for the PDU session associated with the relay UE 220. The Remote User ID is an identity of the remote UE 210 user (provided via User Info) that was successfully connected in step 440. The Remote UE info is used to assist identifying the remote UE 210 in the 5GC 240. For IP PDU Session Type, the Remote UE info is Remote UE IP info. For Ethernet PDU Session Type, the Remote UE info is Remote UE MAC address which is detected by the relay UE 220. For Unstructured PDU Session Type, the Remote UE info contains the PDU session ID. The SMF 243 may store the Remote User IDs and the related Remote UE info (if available) in the relay UE 220's SM context for this PDU session associated with the relay UE 220.

For IP info, the following principles apply:
for IPv4, the relay UE 220 shall report TCP/UDP port ranges assigned to individual remote UE(s) 210 (along with the Remote User ID);
for IPv6, the relay UE 220 shall report IPv6 prefix(es) assigned to individual remote UE(s) 210 (along with the Remote User ID).

The Remote UE Report message shall be sent when the remote UE 210 disconnects from the relay UE 220 (e.g. upon explicit layer-2 link release or based on the absence of keep alive messages over PC5) to inform the SMF 243 that the remote UE(s) 210 have left.

In the case of Registration Update procedure involving SMF change, the Remote User IDs and related Remote UE info corresponding to the connected Remote UEs 210 are transferred to the new SMF as part of SM context transfer for the relay UE 220.

After being connected to the relay UE 220, the remote UE 210 may keep performing the measurement of the signal strength of PC5 unicast link with the relay UE 220 for relay reselection.

In the TR 23.752 v0.5.0 clause 6.7, a layer-2 based UE-to-Network relay is described. The architecture model using a layer-2 based relay is similar to that shown in

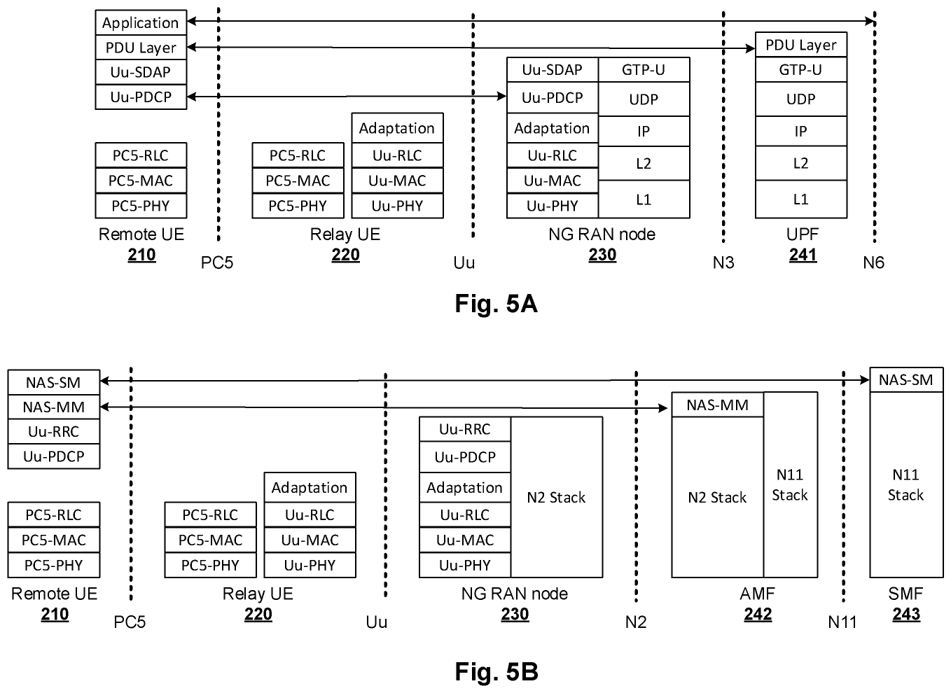

FIG. 2, and therefore the detailed description thereof is omitted for simplicity. Next, a detailed description of the control plane and user plane protocol stacks for supporting Layer 2 relay UE will be given with reference to FIG. 5A and FIG. 5B.

FIG. 5A and FIG. 5B are diagrams illustrating exemplary User Plane (UP) and Control Plane (CP) protocol stacks for an architecture model using a layer 2 (L2) UE-to-Network relay, respectively, in which relay selection for transmission over sidelink according to an embodiment of the present disclosure may be applicable.

FIG. 5A illustrates the protocol stack for the user plane transport, related to a PDU Session, including a layer 2 relay UE 220. The PDU layer corresponds to the PDU carried between the remote UE 210 and the Data Network (DN) over the PDU session. The SDAP and PDCP protocols are as specified in TS 38.300. It is important to note that the two endpoints of the PDCP link are the remote UE 210 and the NG RAN node 230. The relay function is performed below PDCP. This means that data security is ensured between the remote UE 210 and the NG RAN node 230 without exposing raw data at the relay UE 220.

The adaptation layer within the relay UE 220 and the NG-RAN node 230 can differentiate signalling radio bearers (SRBs) and data radio bearers (DRBs) for a particular remote UE 210. The adaption layer is also responsible for mapping PC5 traffic to one or more DRBs of the Uu.

FIG. 5B illustrates the protocol stack of the NAS connection for the remote UE 210 to the NAS-MM and NAS-SM components. The NAS messages are transparently transferred between the remote UE 210 and the NG RAN node 230 over the layer 2 relay UE 220 using:
PDCP end-to-end connection where the role of the relay UE 220 is to relay the PDUs over the signalling radio bear without any modifications.
N2 connection between the NG RAN node 230 and AMF 242 over N2.
N11 connection between the AMF 242 and SMF 243 over N11.

The role of the relay UE 220 is to relay the PDUs from the signalling radio bearer without any modifications.

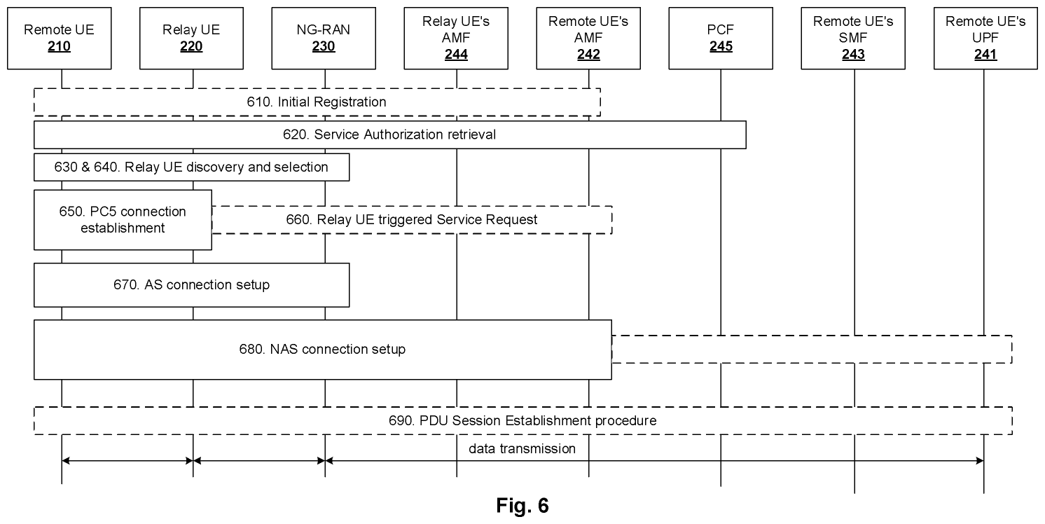

FIG. 6 is a diagram illustrating an exemplary message flow between the nodes of the architecture model shown in FIG. 5 for sidelink relay.

At step 610, if in coverage, the remote UE 210 and relay UE 220 may independently perform the initial registration to the network according to registration procedures in TS 23.502. The allocated 5G GUTI of the remote UE 210 is maintained when later NAS signalling between remote UE 210 and the network is exchanged via the relay UE 220. Further, please note that the current procedures shown here assume a single hop relay, and the present disclosure is not limited thereto.

At step 620, if in coverage, the remote UE 210 and the relay UE 220 may independently get the service authorization for indirect communication from the network. Service authorization and parameters provisioning for relay operation may be performed for the relay UE 220 and remote UE 210.

If the remote UE 210 is not in coverage, the pre-configured information will be used. If needed, the PCF 245 could update the authorization information after step 680.

If the remote UE 210 has not performed the Initial Registration, the remote UE 210 can perform the Initial Registration via the Indirect Network Communication in step 680.

At steps 630 & 640, the remote UE 210 and the relay UE 220 may perform relay UE 220 discovery and selection. The relay UE 220 can perform relay discovery in both CM_IDLE and CM_CONNECTED.

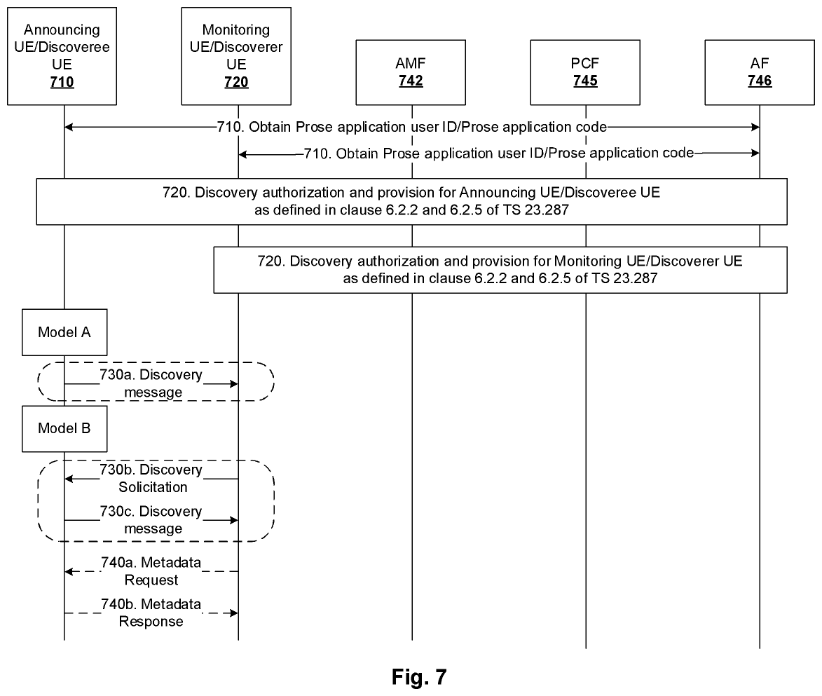

For details of relay discovery and selection, please refer to the following embodiments described with reference to FIG. 7 through FIG. 13.

At step 650, the remote UE 210 may initiate a one-to-one communication connection with the selected relay UE 220 over PC5.

At step 660, if the relay UE 220 is in CM_IDLE state, triggered by the communication request received from the remote UE 210, the relay UE 220 may send a Service Request message to its serving AMF 244.

The relay UE 220's AMF 244 may perform authentication of the relay UE 220 based on NAS message validation and if needed the AMF 244 will check the subscription data. The relay UE 220's AMF 244 may interact with the remote UE 210's AMF 242 and the relay UE 220's PCF 245 for authorization.

At step 670, the remote UE 210 may send AS messages to the NG-RAN node 230 via the relay UE 220, to establish an AS Connection with the same NG-RAN node 230 serving the relay UE 220.

At step 680, the remote UE 210 may send a NAS message to the serving AMF 242. The NAS message is encapsulated in an RRC message that is sent over PC5 to the relay UE 220, and the relay UE 220 may forward the message to the NG-RAN node 230. The NG-RAN node 230 may derive the remote UE 210's serving AMF 242 and forward the NAS message to this AMF 242.

If the remote UE 210 has not performed the initial registration to the network in step 610, the NAS message is initial registration message. Otherwise, the NAS message is either a service request message, or a mobility or periodic Registration message.

If the remote UE 210 performs initial registration via the relay UE 220, the remote UE 210's serving AMF 242 may perform authentication of the remote UE 210 based on NAS message validation and if needed the remote UE 210's AMF 242 checks the subscription data.

For service request case, User Plane connection for PDU Sessions can also be activated.

At step 690, the remote UE 210 may trigger the PDU Session Establishment procedure as defined in clause 4.3.2.2 of TS 23.502. The remote UE 210 allowed PDU session related attributes while operating via the relay UE 220 are provided during the registration procedure or through pre-configuration as described in step 610.

Finally, the data may be transmitted between the remote UE 210 and the UPF 241 via the relay UE 220 and the NG-RAN node 230. The relay UE 220 may forward all the data messages between the remote UE 210 and the NG-RAN node 230 using RAN specified L2 relay method.

Further, if the relay UE 220 disconnects, the NG-RAN node 210 will trigger the AN release procedure of the remote UE 210 and the remote UE 210 goes to CM-IDLE.

As described in clause 6.1 of TR 23.752, the discovery procedure which is being studied for NR Rel-17 is based on 5GC architecture, including authorization and provision, announcing and monitoring procedures, and protocol for discovery as detailed in clause 6.1.2 of TR 23.752. In EPS, there are two types of relay discovery: open and restricted. Open discovery is the case where there is no explicit permission that is needed from the UE being discovered, whereas restricted discovery only takes place with explicit permission from the UE that is being discovered. Besides, there are two models for relay discovery exists in EPS: Model A and Model B. These two models are re-proposed in NR as the same mechanism in EPS.

FIG. 7 is a diagram illustrating an exemplary message flow for a relay discovery procedure in which relay selection for transmission over sidelink according to an embodiment of the present disclosure may be applicable. For the relay discovery authorization and provision to the UEs (e.g. the announcing UE/discoveree UE 710, the monitoring UE/discoverer UE 720, etc.), it is expected the AF 746 can provide the groups and/or service information to the PCF 745, for example, via NEF, and the PCF 745 provides the authorization to the UEs according to the received information from the AF 746. The authorization and provision procedures in clauses 6.2.2 and 6.2.5 of TS 23.287 may be reused to provide at least the following configurations:
1) The AF request sent to the PCF 745 (or via NEF) contains the information as below:
The service information to be directly discovered over PC5 interface. The service information can contain, e.g. Application identifier;
The group information (e.g. the external group identifier) to be directly discovered over PC5 interface;
The information can per announcing and monitoring direction for Model A or per discoverer UE and discoveree UE for Model B;
The area information, e.g. geographical information (longitude/latitude, zip code, etc.)
The metadata information related to application being discovered.

Please note that the metadata information may be configured directly by the AF 746 (e.g. ProSe Application Server) via the PC1 interface, and whether to configure the metadata information to the UEs and to deliver metadata in PC5 interface depends on the size of PC5-S message.
2) The provision to the UE from PCF 745, contains the following information based on the information received from the AF 746 and local policy:
The service information to be directly discovered over PC5 interface. The service information can contain, e.g. Application identifier;
The group information (e.g. the external group identifier) to be directly discovered over PC5 interface;
The area information used for direct discovery over PC5 interface; The area information could be geographical Tracking Area (TA) list. It is expected PCF 745 will map the area information provided by AF 746 to a list of TAs.
Security parameters used for direct discovery over PC5.

Please note that Uu RAT restriction is not applied to PC5 operations for the UE. Uu RAT information is not needed to be provisioned in the UE, e.g. to authorize the UE to send or monitor direct discovery message only when the UE camps on NR.

If the AMF 742 determines the UE is authorized to use relay discovery based on the authorized area information, the AMF 742 may indicate that the UE is authorized to use relay discovery over PC5 interface to corresponding NG-RAN during N2 establishment for the UE.

At step 710, the UEs may obtain ProSe application user ID and ProSe application code for ProSe direct discovery using application layer mechanisms. The application layer in the UE provides application user ID and the application identifier to the ProSe Application Function. The ProSe Application Function allocates a ProSe application user ID and ProSe application code to the application layer in the UE.

At step 720, the UE may obtain the authorization and provision for announcing discovery and/or for monitoring/ solicitation discovery.

At step 730a, when the announcing UE 710 is triggered e.g. by an upper layer application to announce availability for interested groups and/or for interested applications, if the UE 710 is authorised to perform the announcing UE procedure for the interested groups and/or the interested applications in step 720, then the UE 710 shall generate a PC5 direct discovery message for announcement and includes the following information in this message. The announcing UE 710 may compute a security protection element (e.g. for integrity protection) and appends it to the PC5 message:
1) ProSe UE ID e.g. ProSe application user ID, Layer 2 ID.
2) The group ID(s) provided by the application layer.
3) The application ID(s) or ProSe application code(s) provided the application layer.

When the monitoring UE 720 is triggered e.g. by an upper layer application or by the user to monitor proximity of other UEs for the interested group(s) and/or interested applications, and if the UE 720 is authorised to perform the monitoring procedure for the group(s) and/or applications, then the UE 720 may monitor the discovery message. The monitoring UE 720 may verify the security protection element using the provisioned security parameters corresponding to the application. If the verification of the security protection element succeeds, the service is successfully discovered by the monitoring UE 720. The monitoring UE 720 may then notify the application layer using the result of the discovery.

At step 730b, when the discoverer UE 720 is triggered e.g. by an upper layer application or by the user to discover other UEs for the interested group(s) and/or interested applications, and if the UE 720 is authorised to perform the discovery solicitation procedure for the group(s) and/or applications in step 720, then the UE 720 may send solicitation message with the following information of discoverer:
1) ProSe UE ID,
2) group ID(s)
3) application ID(s) or ProSe application code(s).

The discoverer UE 720 may compute a security protection element (e.g. for integrity protection) and appends it to the PC5 message.

If the discoveree UE 710 is able to and authorised to respond to the discovery solicitation according to the received information in the solicitation message, then it responds to the discovery message with the discoveree ProSe UE ID, the supported application ID(s) or ProSe application code(s) and group ID(s).

At step 740a, if the monitoring UE/discoverer UE 720 wants to request metadata corresponding to the discovered service in step 730, the monitoring UE/discoverer UE 720 may send a unicast metadata request message to request discovery metadata. The monitoring UE/discoverer UE 720 may use the Layer 2 ID of announcing UE/discoveree UE 710 (received in step 730a or 730b) to send the Metadata Request message.

At step 740b, the announcing UE/discoveree UE 710 may respond with the Metadata Response message. The announcing UE/discoveree UE 710 may include the metadata information in the Metadata Response message.

Further, as described in TS 23.501 clause 5.7.1.8, UL and DL Session-AMBR (Aggregate Maximum Bit Rate) shall be enforced by the UPF, if the UPF receives the Session-AMBR values from the SMF as described in clause 5.8.2.7 and clause 5.8.2.11.4 in TS 23.501.

For UL Classifier PDU Sessions, UL and DL Session-AMBR (see clause 5.7.2.6 in TS 23.501) shall be enforced in the SMF selected UPF that supports the UL Classifier functionality. In addition, the DL Session-AMBR shall be enforced separately in every UPF that terminates the N6 interface (i.e. without requiring interaction between the UPFs) (see clause 5.6.4 in TS 23.501).

For multi-homed PDU Sessions, UL and DL Session-AMBR shall be enforced in the UPF that supports the Branching Point functionality. In addition, the DL Session-AMBR shall be enforced separately in every UPF that terminates the N6 interface (i.e. without requiring interaction between the UPFs) (see clause 5.6.4).

NOTE: The DL Session-AMBR is enforced in every UPF terminating the N6 interface to reduce unnecessary transport of traffic which may be discarded by the UPF performing the UL Classifier/Branching Point functionality due to the amount of the DL traffic for the PDU Session exceeding the DL Session-AMBR. Discarding DL packets in the UL Classifier/Branching Point could cause erroneous PDU counting for support of charging

The (R)AN shall enforce UE-AMBR (see clause 5.7.2.6 in TS 23.501 [4) in UL and DL per UE for Non-GBR QoS Flows.

The UE shall perform UL rate limitation on PDU Session basis for Non-GBR traffic using Session-AMBR, if the UE receives a Session-AMBR.

MBR per SDF is mandatory for GBR QoS Flows but optional for Non-GBR QoS Flows. The MBR is enforced in the UPF.

The MFBR is enforced in the UPF in the Downlink for GBR QoS Flows. The MFBR is enforced in the (R)AN in the Downlink and Uplink for GBR QoS Flows. For non-3GPP access, the UE should enforce MFBR in the Uplink for GBR QoS Flows.

The QoS control for Unstructured PDUs is performed at the PDU Session level and in this Release of the specification there is only support for maximum of one 5G QoS Flow per PDU Session of Type Unstructured.

When a PDU Session is set up for transferring unstructured PDUs, SMF provides the QFI which will be applied to any packet of the PDU Session to the UPF and UE.

Specifically, for SL, when network scheduled operation mode is used, the UE-PC5-AMBR for NR based PC5 applies to all types of communication modes, and is used by NG-RAN for capping the UE's NR based PC5 transmission in the resources management. The UE-PC5-AMBR shall be set to the sum of the aggregate maximum bit rate of all types of communication (i.e. unicast, groupcast and broadcast modes) over PC5 reference point.

In the last RAN2 meeting (i.e., RAN2#111-e), it has been agreed that the model A and model B discovery standardized in LTE Rel-12/Rel-13 can be re-used for the Rel-17 sidelink UE-to-NW and UE-to-UE relay.

Please note also that mode A and mode B discovery framework are not supported in Rel-16 NR sidelink as has been decided to merge the link establishment procedure and discovery procedure. However, for sidelink relay in Rel-17 it has been decided to decouple these two procedures and make them independent (as was done for LTE).

In LTE SL relay, relay UE selection and reselection was purely based on measurement of radio channel quality on Uu link and/or PC5 link. A UE is selected as relay only in case its Uu RSRP lies within a region limited by a lower band threshold and an upper band threshold. Meanwhile, a remote UE will trigger relay selection in case the UE is out of coverage or measured RSRP on the Uu connection is below a configured threshold. If relay UE selection is triggered, the remote UE would monitor all possible discovery messages, and selects a set of candidate relay UEs if their PC5 connection quality measurements are above the configured threshold. After that, UE with strongest PC5 connection within the set will be selected as the relay UE. Relay UE reselection will be triggered in case the PC5 quality between the remote UE and the relay UE is below a configured threshold. In case relay UE reselection is triggered, the remote UE may repeat the discovery procedure to find candidate relay UEs, if the previous search results are not valid any longer.

As a conclusion, the existing relay selection and reselection procedure does not consider any bit rate limitation or capacity limit of the link (or in general, any QoS parameter), which may cause the issue that selected relay UE has not enough free capacity left. That may affect remote UE's QoS satisfaction negatively.

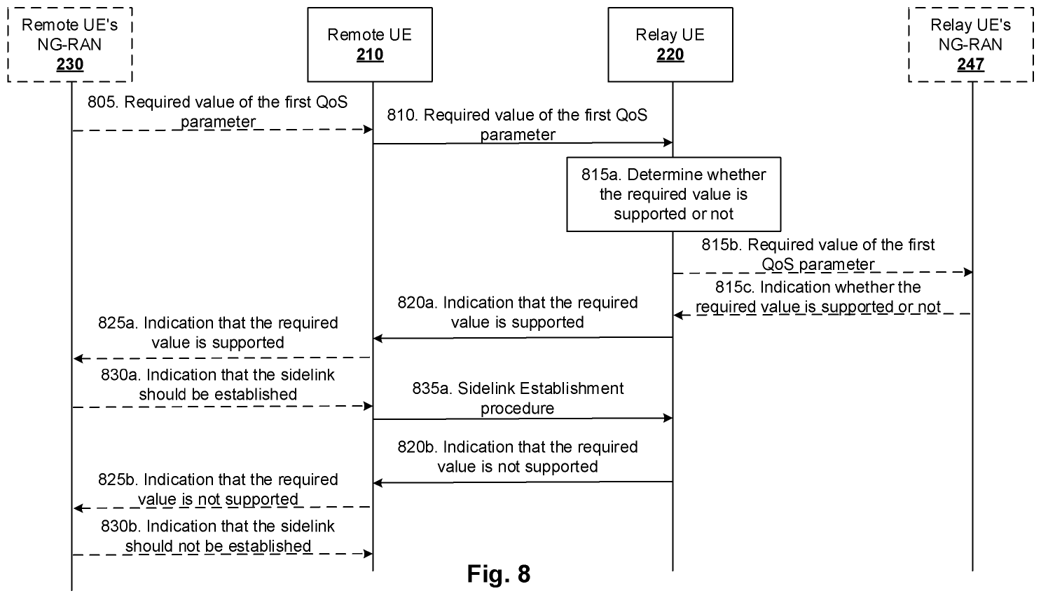

Next, a detailed description of several embodiments of the present disclosure will be described with reference to FIG. 8 through FIG. 13.

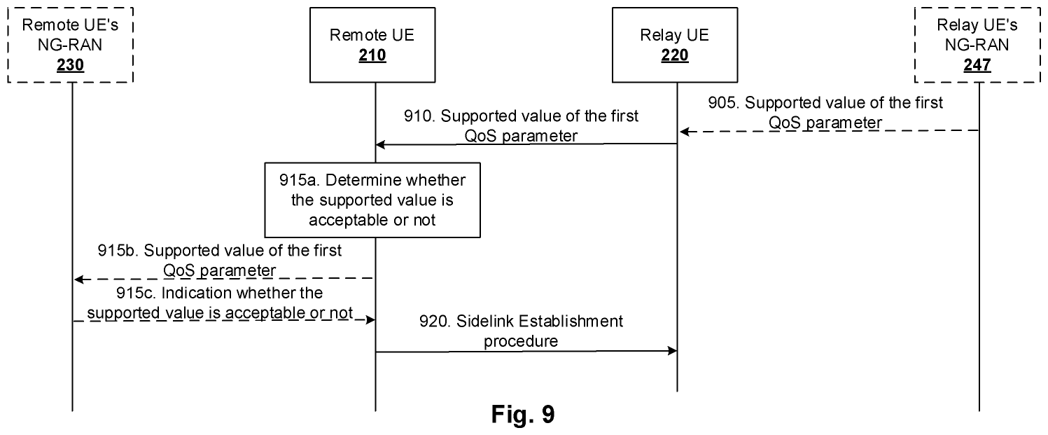

In the embodiments shown in FIG. 8 and FIG. 9, during a relay selection and reselection procedure in a relay scenario, at least one QoS parameter indicating the supported QoS parameter (e.g., maximum bit rate, such as AMBR, or MFBR) of the relay UE 220 and/or the required QoS parameter of the remote UE is exchanged between the relay UE 220 and the remote UE 210. This QoS parameter may be transmitted in a discovery message, or using a separate control message. This QoS parameter may be set to indicate the (supported/required) maximum bit rate per UE, per session, per RAT, per link, per hop, per flow or per radio bearer. There may be multiple such QoS parameters exchanged between the relay UE 220 and the remote UE 210. In this case, in order to obtain the total maximum bit rate for the UE 210, all these QoS parameters can be considered. These maximum bit rate parameters are therefore considered in the decision procedure (e.g., selection and reselection of relay UE 220, or the relay UE 220 decides if to serve the remote UE 210).

FIG. 8 is a diagram illustrating an exemplary message flow for relay selection initiated by a remote UE 210 according to an embodiment of the present disclosure. As shown in FIG. 8, the procedure may begin with step 810 where the remote UE 210 may transmit, to the relay UE 220, a first message comprising a first QoS parameter which has a first value required by the remote UE 210. In some embodiments, for example, embodiments where the remote UE 210 is in-coverage and served by an NG-RAN node 230, the required first value of the first QoS parameter may be received from the serving NG-RAN node 230.

At step 815a, upon reception of the first QoS parameter having the first value, the relay UE 220 may determine whether such a value can be supported or not. In some other embodiments, when the relay UE 220 is in-coverage and served by its serving NG-RAN node 247, this required first value of the first QoS parameter may be transferred to the NG-RAN node 247 at step 815b and the NG-RAN node 247 or any other node associated with the NG-RAN node 247 may make such a determination for the relay UE 220, and the result will be transferred back to the relay UE 220 at step 815c.

In this case, upon reception of the message, a relay capable UE can determine if itself can be a relay UE for the remote UE which has sent the message. To make determination, this relay capable UE not only considers radio channel quality indicators, but also considers the required QoS parameter (e.g., maximum bit rate) of the remote UE indicated in the message.

In some embodiments, the relay UE 220 may determine to not act as a relay UE for the remote UE 210 if it cannot fulfill the required first value on PC5 link from the remote UE 210 towards the relay UE 220 (that is, egress direction). In more details, for transmission direction from the remote UE 210 towards the relay UE 220, the remote UE 210's required first value cannot be met by the relay UE over the PC5 link with the remote UE 210.

In some embodiments, the relay UE 220 may determine to not act as a relay UE for the remote UE 210 if it is not able to fulfill the required first value on the ingress link towards the remote UE 210. In more details, the remote UE 210's required first value of the first QoS parameter cannot be supported by the relay UE 220 on the ingress link towards the remote UE 210.

In some embodiments, the relay UE 220 may determine to act as a relay UE for the remote UE 210 in terms of QoS satisfaction, it may indicate this to the remote UE 210, optionally together with the supported value of the QoS parameters. For UE-to-Network relay, it may also indicate this to the Network.

No matter how the determination is made, the relay UE 220 may indicate to the remote UE 210 at step 820a that the required value is supported by the relay UE 220. Upon reception of this indication, the remote UE 210 itself and/or the NG-RAN node 230 may determine to select the relay UE 220 as the serving relay UE at steps 825a, 830a, and initiate a sidelink establishment procedure with the relay UE 220 at step 835a.

Alternatively, the relay UE 220 may indicate to the remote UE 210 at step 820b that the required value is not supported by the relay UE 220. Upon reception of this indication, the remote UE 210 itself and/or the NG-RAN node 230 may determine to not select the relay UE 220 as the serving relay UE at steps 825b, 830b, and may try to discover other relay UEs or give up discovering any relay UEs.

FIG. 9 is a diagram illustrating an exemplary message flow for relay selection initiated by a relay UE according to an embodiment of the present disclosure. As shown in FIG. 9, the procedure may begin with step 910 where the relay UE 220 may transmit, to the remote UE 210, a first message comprising a first QoS parameter which has a first value supported by the relay UE 220. In some embodiments, for example, embodiments where the relay UE 220 is in-coverage and served by an NG-RAN node 247, the supported first value of the first QoS parameter may be received from the serving NG-RAN node 247.

At step 915a, upon reception of the first QoS parameter having the first value, the remote UE 210 may determine whether such a value can be accepted or not. In some other embodiments, when the remote UE 210 is in-coverage and served by its serving NG-RAN node 230, this supported first value of the first QoS parameter may be transferred to the NG-RAN node 230 at step 915b and the NG-RAN node 230 or any other node associated with the NG-RAN node 230 may make such a determination for the remote UE 210, and the result will be transferred back to the remote UE 210 at step 915c.

In some embodiments, upon reception of the message, the remote UE 210 may determine whether to select this relay UE 220 as a relay UE. To make determination, the remote UE 210 will not only consider radio channel quality indicators, but also consider the first value of the first QoS parameter indicated by this relay UE 220 in the first message.

In some embodiments, the remote UE 210 may determine to not select the relay UE 220 as a relay UE if the relay UE 220 does not fulfill the required value of the first QoS parameter on PC5 ingress link towards this remote UE 210. In more details, for transmission direction from the relay UE 220 towards this remote UE 210, the remote UE 210's required first value is beyond the value of the first QoS parameter that can be supported by this relay UE 220 (i.e., remote UE 210's PC5 ingress link).

In some embodiments, the remote UE 210 may determine to not select the relay UE 220 as a relay UE if the relay UE 220 does not fulfill the required first value of the first QoS parameter on the egress link of the remote UE 210. In more details, the remote UE 210's required value is beyond the value that can be supported by this relay UE 220 on the egress link of the remote UE 210.

No matter how the determination is made, the remote UE 210 may initiate a sidelink establishment procedure with the relay UE 220 at step 920 if the supported first value is acceptable. Alternatively, the remote UE 210 may determine that the supported first value is not accepted, and then the remote UE 210 may try to discover other relay UEs or just simply do nothing.

With the procedures described with reference to FIG. 8 and FIG. 9, the latency, power consumption, and signaling overhead are improved with performing the discovery procedure in the UE-to-NW and UE-to-UE relay scenarios. This will be particular important when the requirements on public safety and V2X as well as commercial use cases need to be met.

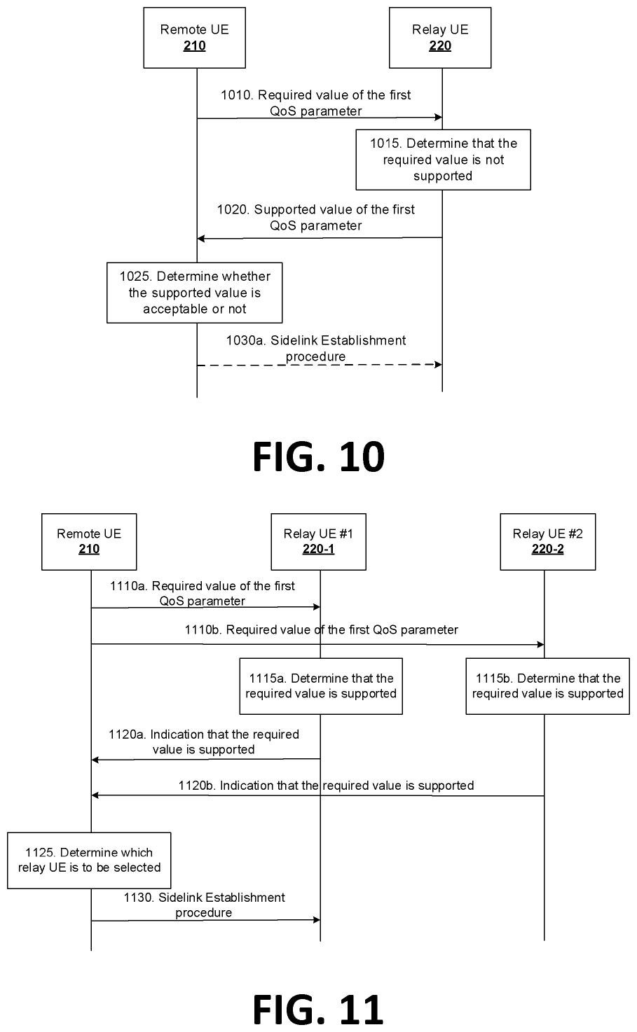

FIG. 10 is a diagram illustrating an exemplary message flow for relay selection involving parameter negotiation according to an embodiment of the present disclosure. Some of the steps shown in FIG. 10 (e.g., steps 1010, 1015, and 1030a) are similar to those shown in FIG. 8 (e.g., steps 810, 815a, and 835a), and a detailed description thereof is omitted.

At step 1015, upon reception of the required value of the first QoS parameter from the remote UE 210, the relay UE 220 may determine whether it can be supported or not. When determining that the required value cannot be supported by the relay UE 220, the relay UE 220 may transmit a second message comprising the first QoS parameter which has a second value supported by the relay UE 220, instead of or in addition to an indication that the required value is not supported shown at step 820b of FIG. 8.

At step 1025, upon reception of the second value supported by the relay UE 220, the remote UE 210 may determine whether the second value can be accepted or not, similar to the step 915a shown in FIG. 9, and may initiate a sidelink establishment procedure if accepted.

In this embodiment, in case the relay UE 220 cannot fulfill the required QoS parameter indicated by the remote UE 210, it may report its supported value of the QoS parameter to the remote UE 210. The report may be triggered upon reception of a request message from the remote UE 210. In the request message, the remote UE 210 may also indicate its required value of the QoS parameter.

FIG. 11 is a diagram illustrating an exemplary message flow for relay selection involving multiple relay UEs 220 according to an embodiment of the present disclosure. In this embodiment, in case the remote UE 210 receives supported QoS parameters from one or multiple relay UEs 220, the remote UE 210 may take one of the below actions:
If more than one relay UEs 220 can support the remote UE 210's required QoS parameter, the remote UE 210 may select the one with the best link quality as the relay UE candidate.
If more than one relay UEs 220 fulfill the radio link quality based criteria (e.g., measured radio link quality is above a configured threshold), the remote UE 210 may select the one with the highest supported QoS parameter as the relay UE candidate regardless if the selected relay UE fulfills its required maximum bit rate or not.
Under either of the above hypothesis, the remote UE randomly select one of those candidates as the relay UE for building up a sidelink.

Some of the steps shown in FIG. 11 (e.g., steps 1110a/1110b, 1115a/1115b, and 1120a/1120b) are similar to those shown in FIG. 8 (e.g., steps 810, 815a, and 835a), and a detailed description thereof is omitted.

At step 1125, the remote UE 210 may determine which relay UE is to be selected, for example, as mentioned above, and at step 1130, the remote UE 210 may initiate a sidelink establishment procedure with the selected relay UE 210 (e.g., the relay UE #1 220-1).

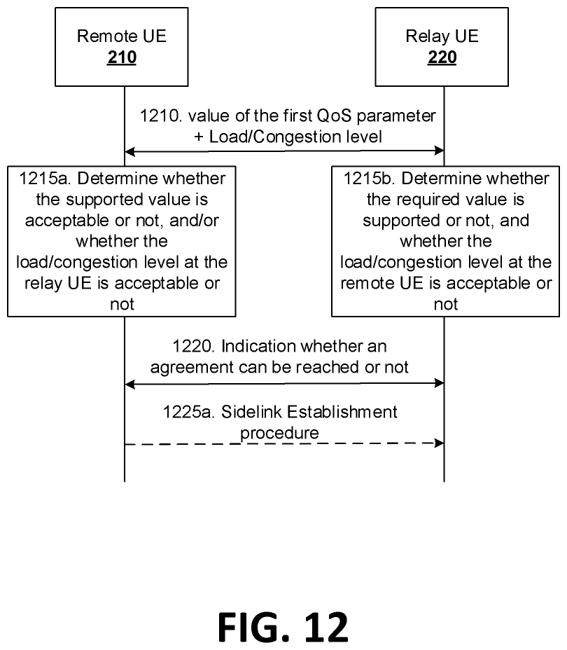

FIG. 12 is a diagram illustrating an exemplary message flow for relay selection involving other parameters than the quality of service (QoS) parameters according to an embodiment of the present disclosure. In this embodiment, during a relay UE selection/reselection procedure in a relay scenario, other radio channel quality indicators are considered in the decision procedure (e.g., selection and reselection of relay UE). For example, the indicators may indicate “load” and/or “congestion” level of the link such as Reference Signal Received Quality (RSRQ), Received Signal Strength Indicator (RSSI), Signal-to-Interference and Noise Ratio (SINR), channel busy ratio (CBR) etc. In some embodiments, the “load” and/or “congestion” indicators may also be exchanged between the remote UE 210 and the relay UE 220.

The steps shown in FIG. 12 are similar to those shown in FIG. 8 and FIG. 9, and therefore a detailed description thereof is omitted except for the additional parameters involved.

To be specific, at the step 1210, the first message comprising the first QoS parameter (e.g., maximum bit rate of the relay link), which is exchanged between the remote UE 210 and the relay UE 220 may further comprise a second parameter indicating a load level and/or a congestion level at the remote UE 210 or the relay UE 220 from which the first message is transmitted.

Further, at the steps 1215a/1215b, the remote UE 210 and/or the relay UE 220 may determine whether the relay UE 220 is a relay UE candidate or not (or the relay UE 220 can serve the remote UE 210 or not) in response to determining that the load level and/or the congestion level is acceptable or not by the remote UE 210 or the relay UE 220 to which the first message is transmitted.

At step 1220, an indication whether an agreement on the load/congestion level in addition to the first QoS parameter can be reached or not may be exchanged between the remote UE 210 and the relay UE 220, and at step 1225a, a sidelink establishment procedure may be triggered if the indication indicates that the agreement can be reached.

In some other embodiments, during a relay UE selection/reselection procedure in a relay scenario, an admission control procedure may be introduced. Upon reception of a request message (e.g., a discovery message) from a node (e.g., the remote UE 210 or the relay UE 220), the admission control procedure may consider all possible inputs such as QoS parameters (e.g., bit rate, latency, jitter, packet loss, packet delay budget, mean opinion score (MOS), or any other QoS parameters, and radio channel quality indicators such as RSRP, RSRQ, RSSI, SINR etc. A relay UE may be selected as a relay candidate UE for a remote UE only in case the admission control procedure admits the request from the remote UE.

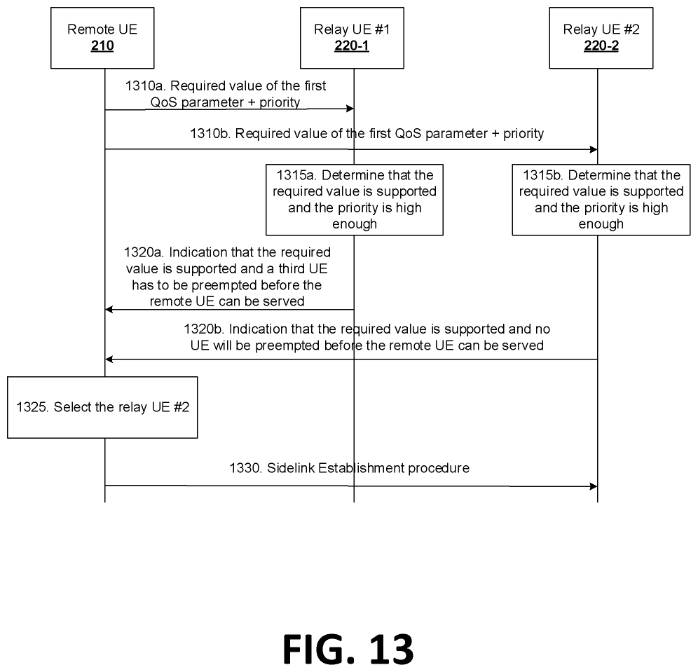

FIG. 13 is a diagram illustrating an exemplary message flow for relay selection involving priority according to an embodiment of the present disclosure. In this embodiment, during a relay UE selection/reselection procedure in a relay scenario, at least one priority index may be included in the first message (e.g., discovery message) sent from the remote UE 210 to the relay UE 220. This priority index may be used to prioritize the remote UE 210 over other UEs in case there are no sufficient resources to serve all remote UEs in a relay path. This priority level could be set per UE, per RAT, per link etc. In this case, the relay UE 220 will only accept discovery request from the remote UE 210 in case there are low priority remote UEs connecting to this relay UE 220, which can be pre-empted in order to release sufficient resources to admit this remote UE 210. A pre-emption can be performed on one single hop or multiple hops of a relay path.

In addition, a UE capability bit may be defined for the remote UE 210 to indicate whether this UE supports to be pre-empted by another higher priority remote UE when connecting to the relay UE 220. A UE capability bit may be defined for the relay UE 220 to indicate whether this UE supports pre-emption function, i.e., it can release resources occupied by lower priority remote UEs to serve higher priority remote UEs.

Upon reception of a discovery message from the remote UE 210, the relay UE 220 may indicate at least one of the below information to the remote UE 210:
whether the required first value of the first QoS parameter can be fulfilled or not;
whether the relay UE 220 supports a priority based preemption; and
whether another UE has to be preempted by the relay UE 220 before the sidelink between the remote UE 210 and the relay UE 220 can be established.

During a relay UE selection/reselection procedure, the remote UE 210 may prioritize the relay UE 220 supporting pre-emption function over another relay UE not supporting pre-emption function.

The steps shown in FIG. 13 are similar to those shown in FIG. 11, and therefore a detailed description thereof is omitted except for the priority involved.

In addition to the required value, the first message transmitted at steps 1310a and 1310b from the remote UE 210 to the relay UEs (e.g. 220-1 and 220-2) may further comprise an indicator of its priority level.

At steps 1315a and 1315b, the relay UEs 220-1 and 220-2 may determine, respectively and independently, whether the required value can be supported or not and whether the priority level is high enough or not if the required value cannot be supported with the current capacity of the link.

At step 1320a, the relay UE #1 220-1 returns to the remote UE 210 an indication that the required value may be supported and another UE has to be preempted (e.g., disconnected) before the remote UE 210 can be served. By contrast, at step 1320b, the relay UE #2 220-2 returns to the remote UE 210 an indication that the required value may be supported and no UE will be preempted before the remote UE 210 can be served.

In such a case, the remote UE 210 may determine, at step 1325, to select the relay UE #2 220-2 and at step 1330 initiate a sidelink establishment procedure with the selected relay UE #2 220-2. In this way, the overall link resource may be fully utilized, such that a global optimization of the resource usage can be achieved.

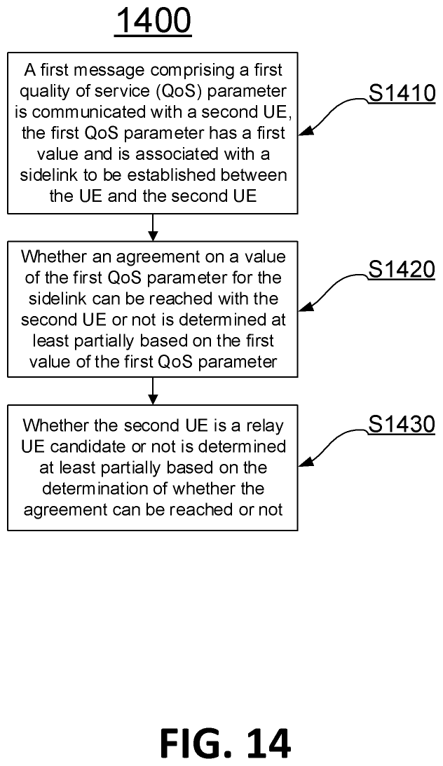

FIG. 14 is a flow chart of an exemplary method 1400 at a remote UE for selecting a relay UE for transmission over sidelink according to an embodiment of the present disclosure. The method 1400 may be performed at a remote UE (e.g., the remote UE 210) for selecting a relay UE for transmission over sidelink. The method 1400 may comprise steps S1410, S1420, and S1430. However, the present disclosure is not limited thereto. In some other embodiments, the method 1400 may comprise more steps, less steps, different steps, or any combination thereof. Further the steps of the method 1400 may be performed in a different order than that described herein. Further, in some embodiments, a step in the method 1400 may be split into multiple sub-steps and performed by different entities, and/or multiple steps in the method 1400 may be combined into a single step.

The method 1400 may begin at step S1410 where a first message comprising a first quality of service (QoS) parameter may be communicated with a second UE, the first QoS parameter may have a first value and be associated with a sidelink to be established between the UE and the second UE.

At step S1420, whether an agreement on a value of the first QoS parameter for the sidelink can be reached with the second UE or not may be determined at least partially based on the first value of the first QoS parameter.

At step S1430, whether the second UE is a relay UE candidate or not may be determined at least partially based on the determination of whether the agreement can be reached or not.

In some embodiments, the step of communicating, with a second UE, a first message comprising a first QoS parameter comprises: transmitting, to the second UE, the first message comprising the first QoS parameter which has the first value required by the UE. In some embodiments, the step of determining whether an agreement can be reached or not comprises: receiving, from the second UE, a second message indicating whether the required first value of the first QoS parameter can be fulfilled or not; and determining whether the agreement can be reached or not depending on whether the required first value of the first QoS parameter can be fulfilled or not.

In some embodiments, the step of determining whether an agreement can be reached or not comprises: receiving, from the second UE, a second message comprising the first QoS parameter which has a second value supported by the second UE; and determining whether the agreement can be reached or not depending on whether the second value of the first QoS parameter is acceptable or not. In some embodiments, when the UE is being served by a serving access network (AN) node, before the step of transmitting, to the second UE, the first message comprising the first QoS parameter, the method further comprises: receiving, from the serving AN node, an indication of the first value of the first QoS parameter.

In some embodiments, the step of communicating, with a second UE, a first message comprising a first QoS parameter comprises: receiving, from the second UE, the first message comprising the first QoS parameter which has the first value supported by the second UE. In some embodiments, the step of determining whether an agreement can be reached or not comprises: determining whether the agreement can be reached or not depending on whether the first value of the first QoS parameter is acceptable or not. In some embodiments, when the UE is being served by a serving access network (AN) node, the step of determining whether an agreement can be reached or not comprises: transmitting, to the serving AN node, an indication of the first value of the first QoS parameter; receiving, from the serving AN node, an indication whether the first value is acceptable or not; and determining whether an agreement can be reached or not depending on the indication.

In some embodiments, the first QoS parameter is related to bit rate. In some embodiments, the first QoS parameter comprises at least one of: ingress aggregate maximum bit rate (AMBR), egress AMBR, ingress maximum flow bit rate (MFBR), and egress MFBR. In some embodiments, the first QoS parameter has a value which is set per UE, per session, per radio access technology (RAT), per link, per hop, per flow, or per radio bearer. In some embodiments, the method further comprises: establishing the sidelink with the second UE in response to determining that the second UE is a relay UE candidate. In some embodiments, if there are more than one relay UE candidate, the method further comprising: selecting one of the relay UE candidates which has the best measured link quality; and establishing the sidelink with the selected relay UE candidate. In some embodiments, if there are more than one relay UE candidate, the method further comprising: determining one or more relay UE candidates from the more than one relay UE candidate, each of which has a higher measured link quality than a configured threshold; selecting a relay UE candidate from the determined one or more relay UE candidates which supports the highest value of the first QoS parameter; and establishing the sidelink with the selected relay UE candidate.

In some embodiments, the first message further comprises a second parameter indicating a load level and/or a congestion level at the UE or the second UE from which the first message is transmitted, and wherein the step of determining whether the second UE is a relay UE candidate or not at least partially based on the determination of whether the agreement can be reached or not further comprises: determining that the second UE is not a relay UE candidate in response to determining that the load level and/or the congestion level is not acceptable by the UE or the second UE to which the first message is transmitted.

In some embodiments, the first message further comprises a third parameter indicating a priority level for one of the UE, the sidelink to be established by the UE, and the RAT to be used for the sidelink. In some embodiments, the step of determining whether the second UE is a relay UE candidate or not at least partially based on the determination of whether the agreement can be reached or not further comprises: receiving, from the second UE, a second message indicating at least one of following: whether the required first value of the first QoS parameter can be fulfilled or not; whether the second UE supports a priority based preemption; and whether a third UE has to be preempted by the second UE before the sidelink between the UE and the second UE can be established, and determining whether the second UE is a relay UE candidate or not depending on the second message.

In some embodiments, the step of determining whether the second UE is a relay UE candidate or not depending on the second message comprises: determining that the second UE is a relay UE candidate based on the second message indicating that the second UE supports the priority based preemption. In some embodiments, the step of determining whether the second UE is a relay UE candidate or not depending on the second message comprises: determining that the second UE is a relay UE candidate based on the second message indicating that the third UE does not have to be preempted by the second UE before the sidelink between the UE and the second UE can be established. In some embodiments, the first message further comprises a fourth parameter indicating whether the second UE supports a priority based preemption or not, wherein the step of determining whether the second UE is a relay UE candidate or not at least partially based on the determination of whether the agreement can be reached or not further comprises: determining that the second UE is not a relay UE candidate if the fourth parameter indicates that the second UE does not support the priority based preemption. In some embodiments, the step of determining whether an agreement on a value of the first QoS parameter can be reached or not comprises: determining whether an agreement on a value of the first QoS parameter can be reached or not by an admission control procedure executed at the UE at least partially based on the first QoS parameter and radio channel quality.

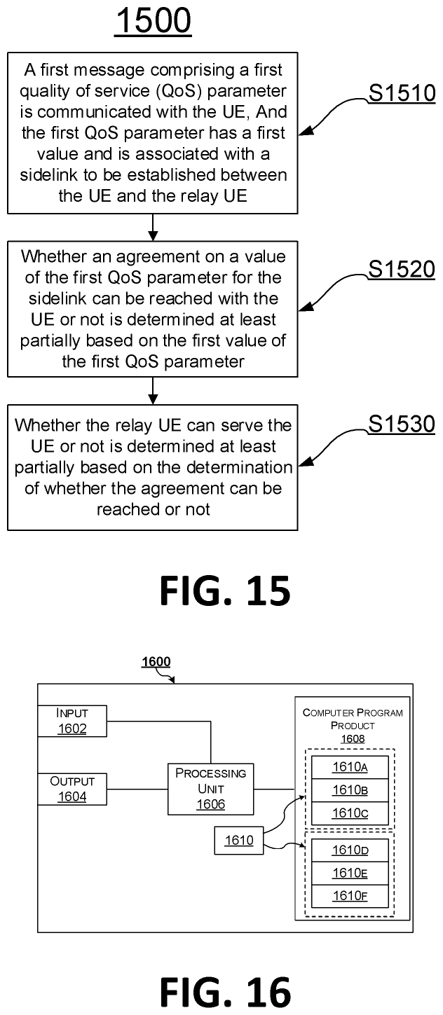

FIG. 15 is a flow chart of an exemplary method 1500 at a relay UE for facilitating a UE in transmission over a sidelink according to an embodiment of the present disclosure. The method 1500 may be performed at a relay UE (e.g., the relay UE 220) for facilitating a UE in transmission over a sidelink. The method 1500 may comprise steps S1510, S1520, and S1530. However, the present disclosure is not limited thereto. In some other embodiments, the method 1500 may comprise more steps, less steps, different steps, or any combination thereof. Further the steps of the method 1500 may be performed in a different order than that described herein. Further, in some embodiments, a step in the method 1500 may be split into multiple sub-steps and performed by different entities, and/or multiple steps in the method 1500 may be combined into a single step.

The method 1500 may begin at step S1510 where a first message comprising a first quality of service (QoS) parameter may be communicated with the UE, and the first QoS parameter may have a first value and be associated with a sidelink to be established between the UE and the relay UE.

At step S1520, whether an agreement on a value of the first QoS parameter for the sidelink can be reached with the UE or not may be determined at least partially based on the first value of the first QoS parameter.

At step S1530, whether the relay UE can serve the UE or not may be determined at least partially based on the determination of whether the agreement can be reached or not.

In some embodiments, the step of communicating, with the UE, a first message comprising a first QoS parameter comprises: receiving, from the UE, the first message comprising the first QoS parameter which has the first value required by the UE. In some embodiments, the step of determining whether an agreement can be reached or not comprises: determining whether the agreement can be reached or not depending on whether the required first value of the first QoS parameter can be fulfilled or not by the relay UE. In some embodiments, the method further comprises: transmitting, to the UE, a second message indicating whether the required first value of the first QoS parameter can be fulfilled or not based on the determining whether the agreement can be reached or not. In some embodiments, the step of determining whether an agreement can be reached or not comprises: transmitting, to the UE, a second message comprising the first QoS parameter which has a second value supported by the relay UE. In some embodiments, when the relay UE is being served by a serving access network (AN) node, the step of determining whether the agreement can be reached or not depending on whether the required first value of the first QoS parameter can be fulfilled or not by the relay UE comprises: transmitting, to the serving AN node, an indication of the required first value of the first QoS parameter; receiving, from the serving AN node, an indication of whether the required first value can be supported or not; and determining whether the agreement can be reached or not based on the indication.

In some embodiments, the step of communicating, with the UE, a first message comprising a first QoS parameter comprises: transmitting, to the UE, the first message comprising the first QoS parameter which has the first value supported by the relay UE. In some embodiments, the step of determining whether an agreement can be reached or not comprises: receiving, from the UE, a second message indicating whether the supported first value of the first QoS parameter can be accepted or not; and determining whether the agreement can be reached or not depending on whether the supported first value of the first QoS parameter can be accepted or not.

In some embodiments, when the relay UE is being served by a serving access network (AN) node, before the step of transmitting, to the UE, the first message comprising the first QoS parameter, the method further comprises: receiving, from the serving AN node, an indication of the first value of the first QoS parameter. In some embodiments, the first QoS parameter is related to bit rate. In some embodiments, the first QoS parameter comprises at least one of: ingress aggregate maximum bit rate (AMBR), egress AMBR, ingress maximum flow bit rate (MFBR), and egress MFBR. In some embodiments, the first QoS parameter has a value which is set per UE, per session, per radio access technology (RAT), per link, per hop, per flow, or per radio bearer. In some embodiments, the method further comprises: establishing the sidelink with the UE.

In some embodiments, the first message further comprises a second parameter indicating a load level and/or a congestion level at the UE or the relay UE from which the first message is transmitted, and wherein the step of determining whether the relay UE can serve the UE or not at least partially based on the determination of whether the agreement can be reached or not further comprises: determining that the relay UE cannot serve the UE in response to determining that the load level and/or the congestion level is not acceptable by the UE or the relay UE to which the first message is transmitted. In some embodiments, the first message further comprises a third parameter indicating a priority level for one of the UE, the sidelink to be established by the UE, and the RAT to be used for the sidelink. In some embodiments, the step of determining whether the relay UE can serve the UE or not further comprises: determining the relay UE cannot serve the UE in response to determining that the priority level is lower than or equal to a priority level associated with a third UE which is currently being served by the relay UE and that the required first value of the first QoS parameter cannot be fulfilled without stopping serving the third UE.

In some embodiments, the step of determining whether the relay UE can serve the UE or not further comprises: transmitting, to the UE, a second message indicating at least one of following: whether the required first value of the first QoS parameter can be fulfilled or not by the relay UE; whether the relay UE supports a priority based preemption; and whether a third UE has to be preempted by the relay UE before the sidelink between the UE and the relay UE can be established.

In some embodiments, the first message further comprises a fourth parameter indicating whether the relay UE supports a priority based preemption or not. In some embodiments, the step of determining whether an agreement on a value of the first QoS parameter can be reached or not comprises: determining whether an agreement on a value of the first QoS parameter can be reached or not by an admission control procedure executed at the relay UE at least partially based on the first QoS parameter and radio channel quality.

FIG. 16 schematically shows an embodiment of an arrangement which may be used in a remote UE and/or a relay UE according to an embodiment of the present disclosure. Comprised in the arrangement 1600 are a processing unit 1606, e.g., with a Digital Signal Processor (DSP) or a Central Processing Unit (CPU). The processing unit 1606 may be a single unit or a plurality of units to perform different actions of procedures described herein. The arrangement 1600 may also comprise an input unit 1602 for receiving signals from other entities, and an output unit 1604 for providing signal(s) to other entities. The input unit 1602 and the output unit 1604 may be arranged as an integrated entity or as separate entities.

Furthermore, the arrangement 1600 may comprise at least one computer program product 1608 in the form of a non-volatile or volatile memory, e.g., an Electrically Erasable Programmable Read-Only Memory (EEPROM), a flash memory and/or a hard drive. The computer program product 1608 comprises a computer program 1610, which comprises code/computer readable instructions, which when executed by the processing unit 1606 in the arrangement 1600 causes the arrangement 1600 and/or the remote UE and/or the relay UE in which it is comprised to perform the actions, e.g., of the procedure described earlier in conjunction with FIG. 4, FIG. 6 through FIG. 15 or any other variant.

The computer program 1610 may be configured as a computer program code structured in computer program modules 1610A-1610C. Hence, in an exemplifying embodiment when the arrangement 1600 is used in the remote UE, the code in the computer program of the arrangement 1600 includes: a module 1610A for communicating, with a second UE, a first message comprising a first quality of service (QoS) parameter, which has a first value and is associated with a sidelink to be established between the UE and the second UE; a module 1610B for determining whether an agreement on a value of the first QoS parameter for the sidelink can be reached with the second UE or not at least partially based on the first value of the first QoS parameter; and a module 1610C for determining whether the second UE is a relay UE candidate or not at least partially based on the determination of whether the agreement can be reached or not.

The computer program 1610 may be further configured as a computer program code structured in computer program modules 1610D-1610F. Hence, in an exemplifying embodiment when the arrangement 1600 is used in the relay UE, the code in the computer program of the arrangement 1600 includes: a module 1610D for communicating, with the UE, a first message comprising a first quality of service (QoS) parameter, which has a first value and is associated with a sidelink to be established between the UE and the relay UE; a module 1610E for determining whether an agreement on a value of the first QoS parameter for the sidelink can be reached with the UE or not at least partially based on the first value of the first QoS parameter; and a module 1610F for determining whether the relay UE can serve the UE or not at least partially based on the determination of whether the agreement can be reached or not.

The computer program modules could essentially perform the actions of the flow illustrated in FIG. 4 and FIG. 6 through FIG. 15, to emulate the remote UE or the relay UE. In other words, when the different computer program modules are executed in the processing unit 1606, they may correspond to different modules in the remote UE or the relay UE.

Although the code means in the embodiments disclosed above in conjunction with FIG. 16 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

Abbreviation Explanation

| | |
|---|---|
| CA | Carrier Aggregation |
| CBR | Channel Busy Ratio |
| CQI | Channel Quality Indicator |
| CSI | Channel State Information |
| DFN | Direct Frame Number |
| DL | Downlink |
| DRX | Discontinuous Reception |
| FDD | Frequency Division Duplex |
| GNSS | Global Navigation Satellite System |
| HARQ | Hybrid automatic repeat request |
| IE | Information Element |
| MAC | Medium Access Control |
| MIB | Master Information Block |
| NSPS | National Security and Public Safety |
| Ooc | Out-of-Coverage |
| PDCCH | Physical Downlink Control Channel |
| PDCP | Packet Data Convergence Protocol |
| PDU | Protocol Data Unit |
| PHY | Physical (layer) |
| PL | Path Loss |
| PMI | Precoding Matrix Indicator |
| ProSe | Proximity Services |
| PSCCH | Physical Sidelink Control Channel |
| PSSCH | Physical Sidelink Shared Channel |
| RL | Relay |
| RLC | Radio link control |
| RM | Remote |
| RI | Rank Indicator |
| RRC | Radio Resource Control |
| RSRP | Reference Signal Received Power |
| RSSI | Received Signal Strength Indicator |
| RX | Receive, receiver |
| SFN | System Frame Number |
| SIB | System Information Block |
| SINR | Signal to interference noise ration |
| SL | Sidelink |
| SLRB | Sidelink Radio Bearer |
| SLSS | Sidelink Synchronization Signals |
| SynchUE | Synchronization UE |
| TDD | Time Division Duplex |
| TETRA | Terrestrial Trunked Radio |
| TX | Transmit, transmitter |
| UE | User Equipment |
| UL | Uplink |
| V2V | Vehicle-to-vehicle |
| V2X | Vehicle-to-anything |

1-43. (canceled)

44. A method at a user equipment (UE) for selecting a relay UE for transmission over a sidelink, the method comprising:
communicating, with a second UE, a first message comprising a first quality of service (QoS) parameter, wherein the first QoS parameter is related to bit rate, has a first value, and is associated with a sidelink to be established between the UE and the second UE;
determining whether an agreement on a value of the first QoS parameter for the sidelink can be reached with the second UE or not at least partially based on the first value of the first QoS parameter; and
determining whether the second UE is a relay UE candidate or not at least partially based on the determination of whether the agreement can be reached or not.

45. The method of claim 44, wherein communicating the first message comprises:
transmitting the first message to the second UE, wherein the first value of the first QoS parameter indicated by the first message is a required first value of the first QoS parameter indicated by the first message as required by the UE; or
receiving the first message from the second UE, wherein the first value of the first QoS parameter indicated by the first message is a supported first value of the first QoS parameter indicated by the first message as supported by the second UE.

46. The method of claim 44, wherein either:
communicating the first message comprises transmitting the first message to the second UE, wherein the first value of the first QoS parameter is a required first value of the first QoS parameter indicated by the first message as required by the UE, and wherein determining whether an agreement can be reached or not comprises:
receiving, from the second UE, a second message indicating whether the required first value of the first QoS parameter can be fulfilled or not, and determining whether the agreement can be reached or not depending on whether the required first value of the first QoS parameter can be fulfilled or not according to the second message; or
receiving, from the second UE, a second message indicating a second value supported by the second UE for the first QoS parameter and determining whether the agreement can be reached or not depending on whether the second value of the first QoS parameter is acceptable or not to the UE; or
communicating the first message comprises receiving the first message from the second UE, and wherein determining whether an agreement can be reached or not comprises determining whether the agreement can be reached or not depending on whether the first value of the first QoS parameter is acceptable or not to the UE.

47. The method of claim 44, wherein either:
communicating the first message comprises transmitting the first message to the second UE, wherein the method further comprises, before transmitting the first message to the second UE, receiving, from a serving access network (AN) node of the UE, an indication of the first value of the first QoS parameter; or
communicating the first message comprises receiving the first message from the second UE, and wherein determining whether an agreement can be reached or not comprises:
transmitting, to a serving access network (AN) node of the UE, an indication of the first value of the first QoS parameter;
receiving, from the serving AN node, an indication of whether the first value is acceptable or not; and
determining whether an agreement can be reached or not depending on the received indication.

48. The method of claim 44, wherein the first QoS parameter comprises at least one of: ingress aggregate maximum bit rate (AMBR), egress AMBR, ingress maximum flow bit rate (MFBR), and egress MFBR.

49. The method of claim 44, further comprising establishing the sidelink with the second UE in response to determining that the second UE is a relay UE candidate.

50. The method of claim 44, further comprising:
determining that multiple UEs are relay UE candidates;
selecting one of the relay UE candidates with which to establish a sidelink, wherein selecting comprises:
selecting one of the relay UE candidates which has the best measured link quality; or
determining, from the relay UE candidates, one or more relay UE candidates that each has a higher measured link quality than a configured threshold and selecting a relay UE candidate from the determined one or more relay UE candidates which supports the highest value of the first QoS parameter; and
establishing the sidelink with the selected relay UE candidate.

51. The method of claim 44, wherein the first message further comprises a second parameter indicating a load level and/or a congestion level at the UE or the second UE from which the first message is transmitted, and wherein determining whether the second UE is a relay UE candidate or not comprises determining that the second UE is not a relay UE candidate in response to determining that the load level and/or the congestion level is not acceptable by the UE or the second UE to which the first message is transmitted.

52. The method of claim 44, communicating the first message comprises transmitting the first message to the second UE, wherein the first value of the first QoS parameter is a required first value of the first QoS parameter indicated by the first message as required by the UE, and wherein determining whether the second UE is a relay UE candidate or not comprises:
receiving, from the second UE, a second message indicating at least one of following:
whether the required first value of the first QoS parameter can be fulfilled or not;
whether the second UE supports a priority based preemption; and
whether a third UE has to be preempted by the second UE before the sidelink between the UE and the second UE can be established, and
determining whether the second UE is a relay UE candidate or not depending on the second message.

53. The method of claim 52, wherein determining whether the second UE is a relay UE candidate or not depending on the second message comprises:
determining that the second UE is a relay UE candidate based on the second message indicating that the second UE supports the priority based preemption; or
determining that the second UE is a relay UE candidate based on the second message indicating that the third UE does not have to be preempted by the second UE before the sidelink between the UE and the second UE can be established.

54. The method of claim 44, wherein the first message further comprises a fourth parameter indicating whether the second UE supports a priority based preemption or not, and wherein determining whether the second UE is a relay UE candidate or not comprises determining that the second UE is not a relay UE candidate if the fourth parameter indicates that the second UE does not support the priority based preemption.

55. The method of claim 44, wherein determining whether an agreement on a value of the first QoS parameter can be reached or not comprises determining whether an agreement on a value of the first QoS parameter can be reached or not by an admission control procedure executed at the UE at least partially based on the first QoS parameter and radio channel quality.

56. A user equipment (UE) for selecting a relay UE for transmission over a sidelink, the UE comprising:
a processor; and
a memory storing instructions which, when executed by the processor, cause the processor to:
communicate, with a second UE, a first message comprising a first quality of service (QoS) parameter, wherein the first QoS parameter is related to bit rate, has a first value, and is associated with a sidelink to be established between the UE and the second UE;
determine whether an agreement on a value of the first QoS parameter for the sidelink can be reached with the second UE or not at least partially based on the first value of the first QoS parameter; and
determine whether the second UE is a relay UE candidate or not at least partially based on the determination of whether the agreement can be reached or not.

57. A method at a relay user equipment (UE) for facilitating a UE in transmission over a sidelink, the method comprising:
communicating, with the UE, a first message comprising a first quality of service (QoS) parameter, wherein the first QoS parameter is related to bit rate, has a first value, and is associated with a sidelink to be established between the UE and the relay UE;
determining whether an agreement on a value of the first QoS parameter for the sidelink can be reached with the UE or not at least partially based on the first value of the first QoS parameter; and
determining whether the relay UE can serve the UE or not at least partially based on the determination of whether the agreement can be reached or not.

58. The method of claim 57, wherein communicating the first message comprises:
receiving the first message from the UE, wherein the first value of the first QoS parameter indicated by the first message is a required first value of the first QoS parameter indicated by the first message as required by the UE; or
transmitting the first message to the UE, wherein the first value of the first QoS parameter indicated by the first message is a supported first value of the first QoS parameter indicated by the first message as supported by the relay UE.

59. The method of claim 57, wherein either:
communicating the first message comprises receiving the first message from the UE, wherein the first value of the first QoS parameter indicated by the first message is a required first value of the first QoS parameter indicated by the first message as required by the UE, and wherein determining whether an agreement can be reached or not comprises determining whether the agreement can be reached or not depending on whether the required first value of the first QoS parameter can be fulfilled or not by the relay UE; or
communicating the first message comprises transmitting the first message to the UE, wherein the first value of the first QoS parameter indicated by the first message is a supported first value of the first QoS parameter indicated by the first message as supported by the relay UE, and wherein determining whether an agreement can be reached or not comprises receiving, from the UE, a second message indicating whether the supported first value of the first QoS parameter can be accepted or not and determining whether the agreement can be reached or not depending on whether the supported first value of the first QoS parameter can be accepted or not.

60. The method of claim 59, wherein communicating the first message comprises receiving the first message from the UE, wherein the first value of the first QoS parameter indicated by the first message is a required first value of the first QoS parameter indicated by the first message as required by the UE, and wherein determining whether an agreement can be reached or not comprises:
transmitting, to the UE, a second message indicating whether the required first value of the first QoS parameter can be fulfilled or not; or
transmitting, to the UE, a second message indicating a second value supported by the relay UE for the first QoS parameter.

61. The method of claim 57, wherein either:
communicating the first message comprises receiving the first message from the UE, wherein the first value of the first QoS parameter indicated by the first message is a required first value of the first QoS parameter indicated by the first message as required by the UE, and wherein determining whether the agreement can be reached or not comprises transmitting, to a serving AN node of the relay UE, an indication of the required first value of the first QoS parameter, receiving, from the serving AN node, an indication of whether the required first value can be supported or not, and determining whether the agreement can be reached or not based on the received indication; or
communicating the first message comprises transmitting the first message to the UE, wherein the first value of the first QoS parameter indicated by the first message is a supported first value of the first QoS parameter indicated by the first message as supported by the relay UE, and wherein the method further comprises, before transmitting the first message to the UE, receiving, from a serving AN node of the relay UE, an indication of the first value of the first QoS parameter.

62. The method of claim 57, wherein the first message further comprises a second parameter indicating a load level and/or a congestion level at the UE or the relay UE from which the first message is transmitted, and wherein determining whether the relay UE can serve the UE or not at least partially based on the determination of whether the agreement can be reached or not comprises determining that the relay UE cannot serve the UE in response to determining that the load level and/or the congestion level is not acceptable by the UE or the relay UE to which the first message is transmitted.

63. The method of claim 57, wherein communicating the first message comprises receiving the first message from the UE, wherein the first value of the first QoS parameter indicated by the first message is a required first value of the first QoS parameter indicated by the first message as required by the UE, wherein the first message further comprises a third parameter indicating a priority level for one of the UE, the sidelink to be established by the UE, and a radio access technology (RAT) to be used for the sidelink, and wherein determining whether the relay UE can serve the UE or not comprises:
determining the relay UE cannot serve the UE in response to determining that the priority level is lower than or equal to a priority level associated with a third UE which is currently being served by the relay UE and that the required first value of the first QoS parameter cannot be fulfilled without stopping serving the third UE; or
transmitting, to the UE, a second message indicating at least one of following:
whether the required first value of the first QoS parameter can be fulfilled or not by the relay UE;
whether the relay UE supports a priority based preemption; and
whether a third UE has to be preempted by the relay UE before the sidelink between the UE and the relay UE can be established.
